(19) United States
(12) Patent Application Publication
(10) Pub. No.: US 2021/0174159 A1
(43) Pub. Date: Jun. 10, 2021

(54) RFID-ENABLED METAL TRANSACTION CARDS WITH FOIL, SPECIAL TEXTURE, COLOR AND CARBON FIBER

(71) Applicant: Federal Card Services, LLC, Cincinnati, OH (US)

(72) Inventor: David Finn, Fussen Weissensee (DE)

(21) Appl. No.: 17/062,591

(22) Filed: Oct. 4, 2020

Related U.S. Application Data
(63) Continuation-in-part of application No. 17/019,378, filed on Sep. 14, 2020.
(60) Provisional application No. 62/979,440, filed on Feb. 21, 2020.
(60) Provisional application No. 62/946,990, filed on Dec. 12, 2019.
(60) Provisional application No. 62/933,526, filed on Nov. 11, 2019.
(60) Provisional application No. 62/911,236, filed on Oct. 5, 2019.

(51) Int. Cl. G06K 19/077

(52) U.S. Cl. CPC G06K 19/0772

(57) ABSTRACT

RFID-enabled composite metal transaction cards may include a security layer comprising a hologram or diffraction grating on a metal layer having a slit. The metal layer may reside on a front or rear face, or as a core layer in the construction of the card. The security layer, with or without a carrier layer, may be hot stamped to the metal layer with a protective hard coating, to camouflage the existence of a discontinuity in the metal layer. The metal layer with slit or slits may be coated with a baked-on-ink to provide color and to partially fill the slit or slits. A metal foil, holofoil or a holographic metal film may be provided with a discontinuity in the form of a slit and may be a decorative foil mounted to a card body containing a metal layer with a slit.

### CROSS-REFERENCES TO RELATED APPLICATIONS

Priority (filing date benefit) is claimed from the following, incorporated by reference herein:
a continuation-in-part of 17019378 filed 14 Sep. 2020
a nonprovisional of 62/979,440 filed 21 Feb. 2020
a nonprovisional of 62/946,990 filed 12 Dec. 2019
a nonprovisional of 62/933,526 filed 11 Nov. 2019
a nonprovisional of 62/911,236 filed 5 Oct. 2019

### FIELD OF THE INVENTION

This disclosure relates to the field of RFID-enabled metal transaction cards (smartcards) with security elements formed on a top or bottom layer, or in a core layer of a card stack-up construction.

This disclosure relates to the assembly of holographic material and other security indicia to a metal layer with a micro-slit forming part of the transaction card.

This disclosure relates to passive metal transaction cards having at least one carbon fiber layer.

This disclosure relates to passive metal transaction cards having at least one metal layer and a special textured metal foil layer which is capable of radio frequency reception and transmission.

This disclosure relates to anti-scratch protective coatings protecting an underlying print layer which require laser treatment to create special thin film effects, laser markings for personalization, and laser engraving for etching features into the surfaces of a metal card such as a payment scheme logo.

This disclosure relates to metal transaction cards solely with a contact interface or a contactless interface, or with dual interface (contact and contactless).

Some of the disclosure(s) herein may also relate to RFID-enabled plastic transaction cards.

### BACKGROUND OF THE INVENTION

The invention is directed to the manufacture of multi-layered (composite) metal cards with RFID slit technology. The term “card”, “smartcard” or “transaction card” as used herein, and addressed in the claims, is intended to include a wide variety of identification and payment cards and objects. The invention may also relate to a single-metal-layer transaction card.

To increase the security of a plastic card, it is known to form a hologram or a diffraction grating on a carrier material mounted to the card body. Generally, the hologram may be formed by a hot stamping method at, or near, the top (or bottom) surface (level) of the plastic card. A disadvantage to such placing of the hologram is that a counterfeiter may be able to alter the card without the tampering being readily apparent or noticed to someone examining or accepting the card.

The hologram may represent the logo of a payment scheme and hot-stamped to a synthetic layer assembled to a metal layer.

In addition to the placement of hologram, the present invention relates to manufacturing RFID-enabled metal transaction cards having selected visual appearance and tactile effects. The latter includes special textures on the card body surface which are capable of acting as a coupling frame to facilitate contactless communication. Also included are transaction cards which may be of the contact only type.

In recent years, more credit card issuers have started offering metal cards. They range widely in their annual fees, additional benefits (airport lounge access, travel credits, Uber credits, Global Entry or TSA Pre-Check credit) and weight. Some people like the feel of a metal credit card and the reactions they get when making purchases.

Metal cards make a statement, with a plethora of metal and metal alloys to choose from, such as aluminum, copper, brass, stainless steel, titanium, tungsten, sterling silver, platinum, palladium and gold. Card designs may include a laser etched text (debossed or embossed), laser engraved or diamond milled logo. The designs may also include a card cut-through and/or an etched recess in the card body with or without a color fill. Various finishes or effects to the metal card body are available and include matt, brushed, satin, mirror (highly polished), prism or plated. Different plating (e.g. gold, rhodium, etc.) and coating techniques (e.g. physical vapor deposition or diamond-like carbon) provide different colors. Color inks may be offset printed, silkscreen printed or digitally printed, with the ink deposited surface protected with a hard coat. Alternatively, the card may have an over-laminate to protect the printing and enhance the durability of the magnetic stripe. Laser etching may also provide different colors to the metal surface. Security elements may include a signature panel, a hologram and a HiCo magnetic stripe. The radius of the card body corners may be customized The edges of the card body may reveal the metal. The construction of a metal card may be a hybrid with different layers of metal, plastic or carbon fiber forming the card body. The outer surface of the metal card body may have a scratch resistant overlay layer which may be laser engravable.

For over a decade, the overlay layer on the outer surface of a financial transaction card, national identity card, secure document and the like have been personalized using laser engraving to scribe information or create a design or logo on or within the laser reactive polymer. The laser treatment could also alter background color to provide predetermined alphanumeric information or patterns. Color change to the polymer was also produced as a gradient, by altering the laser power (fluence) and exposure time. More recently, the application of a laser is used to directly ablate the surface of a metal layer in a transaction card body imparting information with certain color control (oxidation effect) depending on laser settings.

Equally, the creation of a physically embossed surface which may be referred to as “surface embossing” in a polymer layer or a colored polymeric film layer using a lamination process which emulates a traditional gravure process, has been achieved by using lamination plates (metal) with the desired pattern (deboss image). The raised physical nature of the polymer layer provided desirable tactile and visual aspects to the transaction card.

Advances in laser machining tools; screen, digital and 3D printing; inks (high bond inks, metallic inks, pearl inks, varnishes); photo chemical etching of metal; coating processes; metal 3D foiling; and the combination thereof, has opened up the opportunity to create novel features which impart special texture and color to a transaction card.

Metal transaction cards in ISO 7810 standard can be produced with a layer of carbon fiber with the card holder credentials screen printed on the surface. However, carbon fiber cards cannot utilize any surface etching or cut-out areas. In addition, it is difficult to integrate contactless technology using a conventional antenna into a metal card construction with a carbon fiber layer, without destabilizing the mechanical stability of the card.

Some Patents and Publications of Interest

The following patents and/or publications (“references”) may be of interest or relevant to the invention(s) disclosed herein, and some commentary may be provided to distinguish the invention(s) disclosed herein from the following references.

U.S. Pat. No. 10,518,518 (31 Dec. 2019; AmaTech; Finn et al.) discloses smartcards with metal layers manufactured according to various techniques disclosed herein. One or more metal layers of a smartcard stackup may be provided with slits overlapping at least a portion of a module antenna in an associated transponder chip module disposed in the smartcard so that the metal layer functions as a coupling frame. One or more metal layers may be pre-laminated with plastic layers to form a metal core or clad subassembly for a smartcard, and outer printed and/or overlay plastic layers may be laminated to the front and/or back of the metal core. Front and back overlays may be provided. Various constructions of and manufacturing techniques (including temperature, time, and pressure regimes for laminating) for smartcards are disclosed herein. As noted therein:
The coupling frame (CF) 306 features a recess on one side which accommodates an insert referred to, in this instance, as a support panel (SP) 310. The support panel (SP) 310 may be a metal and may be coated in a dielectric or other material to prevent electrical short-circuiting across the slit (S) 307 of the coupling frame (CF) 306. The support panel (SP) 310 may be a non-metal. The primary function of the support panel (SP) 310 is to provide mechanical stability to the coupling frame (CF) 306 across the slit (S) 307 under bending stresses during use of the card. The support panel (SP) 310 is attached to the coupling frame (CF) 306 using an adhesive layer (AL) 309. In this case the layers IPL (304), AL (305) CF (306), AL (309), SP (310), AL (311) and IPL (312) may comprise a subassembly (SAS) 315 which may be laminated together in one or more steps.

U.S. Pat. No. 10,373,920 (6 Aug. 2019; CompoSecure; Herslow) and U.S. Pat. No. 10,332,846 (25 Jun. 2019; CompoSecure; Herslow), incorporated by reference herein, disclose foil composite cards. Composite cards which include a security layer comprising a hologram or diffraction grating formed at, or in, the center, or core layer, of the card. The hologram may be formed by embossing a designated area of the core layer with a diffraction pattern and depositing a thin layer of metal on the embossed layer. Additional layers may be selectively and symmetrically attached to the top and bottom surfaces of the core layer. A laser may be used to remove selected portions of the metal formed on the embossed layer, at selected stages of forming the card, to impart a selected pattern or information to the holographic region. The cards may be “lasered” when the cards being processed are attached to, and part of, a large sheet of material, whereby the “lasering” of all the cards on the sheet can be done at the same time and relatively inexpensively. Alternatively, each card may be individually “lasered” to produce desired alpha numeric information, bar codes information or a graphic image, after the sheets are die-cut into cards.

U.S. Pat. No. 9,542,635 (10 Jan. 2017; CompoSecure; Herslow) discloses foil composite card. Composite cards which include a security layer comprising a hologram or diffraction grating formed at, or in, the center, or core layer, of the card. The hologram may be formed by embossing a designated area of the core layer with a diffraction pattern and depositing a thin layer of metal on the embossed layer. Additional layers may be selectively and symmetrically attached to the top and bottom surfaces of the core layer. A laser may be used to remove selected portions of the metal formed on the embossed layer, at selected stages of forming the card, to impart a selected pattern or information to the holographic region. The cards may be “lasered” when the cards being processed are attached to, and part of, a large sheet of material, whereby the “lasering” of all the cards on the sheet can be done at the same time and relatively inexpensively. Alternatively, each card may be individually “lasered” to produce desired alpha numeric information, bar codes information or a graphic image, after the sheets are die-cut into cards.

U.S. Pat. No. 9,390,363 (12 Jul. 2016; CompoSecure; Herslow et al.) and U.S. Pat. No. 10,452,967 (22 Oct. 2019; CompoSecure; Herslow et al.) incorporated by reference herein, disclose cards with special texture and color. A multi layered card which includes an outer layer of an amorphous laser reactive copolymer material which is embossed with a selected pattern at a selected temperature which is above the glass transition temperature, Tg, of the copolymer and below its melting temperature, Tm. So embossed, the selected pattern is set in the copolymer layer, and its external shape cannot be changed from the embossed form to which it was set at the selected temperature, without destroying the selected pattern. The outer layer may be laminated with the other layers of the card and laser engraved before or after lamination.

U.S. Pat. No. 9,646,234 (9 May 2017; CompoSecure/Citicorp; Thomson et al.) and U.S. Pat. No. 9,440,481 (13 Sep. 2016; CompoSecure/Citicorp; Thomson et al.), incorporated by reference herein, both titled “Transaction card with carbon fiber substructure and method of making same”, describes a transaction card has a substructure consisting at least in part of a layer of fibrous material, such as carbon fiber strands or filaments, arranged in a pre-selected pattern, such as a weave pattern, that is at least partially enclosed by a transparent plastic film. A sheet is laminated on each of two opposing faces of the substructure to form a transaction card core. One or both of the sheets laminated on the opposing faces of the substructure is also made of a transparent material, and one or both of the two opposing faces of the transaction card core can be printed. An over-laminate film, such as a transparent polyvinyl chloride plastic film, can be laminated on each of two opposing faces of the transaction card core.

The Following US Patents and Applications are Referenced

U.S. Pat. No. 10,762,412 (2020 Sep. 1; Lowe et al; CompoSecure)

U.S. Pat. No. 10,679,113 (9 Jun. 2020; Herslow et al.; CompoSecure)

U.S. Pat. No. 10,479,130 (2019 Nov. 19; Herslow et al.; CompoSecure)

U.S. Pat. No. 10,395,153 (2019 Aug. 27; Herslow; CompoSecure)

U.S. Pat. No. 10,311,346 (2019 Jun. 6-4; Herslow; CompoSecure)

U.S. Pat. No. 9,299,020 (2016 Mar. 29; Zimmerman et al.; TheCard)

U.S. Pat. No. 8,393,547 (2013 Mar. 12; Kiekhaefer et al.; Perfect Plastic Printing)

U.S. Pat. No. 7,187,396 (2007 Mar. 6; Carroll, Jr. et al; Engelhard Corporation)

U.S. Pat. No. 7,048,823 (2006 May 23; Bermel; Eastman Kodak Company)

U.S. Pat. No. 6,644,552 (2003 Nov. 11; Herslow; CompoSecure)

U.S. Pat. No. 6,617,515 (2003 Sep. 9; Yeung; Compagnie Plastic Omnium)

U.S. Pat. No. 6,261,348 (2001 Jul. 17; Kwan et al; Marconi Data Systems)

U.S. Pat. No. 6,210,472 (2001 Apr. 3; Kwan et al; Marconi Data Systems)

U.S. Pat. No. 6,133,342 (2000 Oct. 17; Mizobuchi et al; Marconi Data Systems)

U.S. Pat. No. 6,007,929 (1999 Dec. 28; Robertson et al; Infosight Corporation)

U.S. Pat. No. 5,855,969 (1999 Jan. 5; Robertson; Infosight Corporation)

2020/0039280 (6 Feb. 2020; Herslow et al.; CompoSecure)

2019/0378805 (2019 Dec. 12; Herslow; CompoSecure)

2019/0236434 (2019 Aug. 1; Lowe; CompoSecure)

2018/0330214 (2018 Nov. 15; Gao et al.; Giesecke & Devrient)

2008/0296887 (2008 Dec. 4; Baggenstos)

2008/0124498 (2008 May 29; Cole et al.; Ciba Corporation)

Some Additional US Patents and Publications

The following US patents and patent application publications are referenced, some of which may relate to “RFID Slit Technology”:

U.S. Pat. No. 10,599,972 Smartcard constructions and methods

U.S. Pat. No. 10,552,722 Smartcard with coupling frame antenna

U.S. Pat. No. 10,518,518 Smartcards with metal layers and methods of manufacture

U.S. Pat. No. 10,248,902 Coupling frames for RFID devices

U.S. Pat. No. 10,193,211 Smartcards, RFID devices, wearables and methods

U.S. Pat. No. 9,960,476 Smartcard constructions

U.S. Pat. No. 9,836,684 Smartcards, payment objects and methods

U.S. Pat. No. 9,812,782 Coupling frames for RFID devices

U.S. Pat. No. 9,798,968 Smartcard with coupling frame and method of increasing activation distance

U.S. Pat. No. 9,697,459 Passive smartcards, metal cards, payment objects

U.S. Pat. No. 9,634,391 RFID transponder chip modules

U.S. Pat. No. 9,622,359 RFID transponder chip modules

U.S. Pat. No. 9,489,613 RFID transponder chip modules with a band of the antenna extending inward

U.S. Pat. No. 9,475,086 Smartcard with coupling frame and method of increasing activation distance

U.S. Pat. No. 9,390,364 Transponder chip module with coupling frame on a common substrate

2020/0151534 Smartcards with metal layers and methods of manufacture

2020/0050914 Connection bridges for dual interface transponder chip modules

2020/0034578 Smartcard with display and energy harvesting

2020/0005114 Dual interface metal hybrid smartcard

2019/0392283 RFID transponder chip modules, elements thereof, and methods

2019/0197386 Contactless smartcards with multiple coupling frames

2019/0171923 Metallized smartcard constructions and methods

2019/0114526 Smartcard constructions and methods

2018/0341847 Smartcard with coupling frame antenna

2018/0341846 Contactless metal card construction

2018/0339503 Smartcards with metal layers and methods of manufacture

### Some Definitions

Some of the following terms may be used or referred to, herein. Some may relate to background or general knowledge, others may relate to the invention(s) disclosed herein.

Composite Smartcard

“Composite” smartcards are multi-layered cards having at least one layer of plastic, one layer of adhesive, and may have several plastic layers of different synthetic material, may have a thin metal foil layer, and in the case of an RFID-enabled smartcard may also have an antenna for contactless communication. A composite smartcard may also comprise of an edge-to-edge metal layer.

Graphic Arts Foils

Metallic Foils are the most widely recognized stamping foils. They are also the most versatile for stamping a wide range of paper and film substrates, from coated to uncoated to varnishes and to ink coatings while maintaining sheen and brilliance. This also applies to Rotary Metallic Foils.

Pearl Foils provide a translucent ‘Pearlescent’ sheen to stamped products.

Pigment Foils provide a deep solid color with excellent opacity.

Clear Foils provide a clear ‘gloss’ sheen to stamped products.

Holographic Foils are holographic patterns which add distinction to stamped products.

Cold Foils utilize a release and a free radical UV-cured adhesive that works with a printing process and doesn't require the traditional use of heat or a hot stamping die.

Plastics Foils are provided with metallic and holographic shades and in addition, textile foils and decorative finishing foils are used in the graphic arts industry.

Reference is made to: https://www.infinityfoils.com/index2.cfm

Metal Foil Embossing

Applying intricate large area foiling using a rotary screen-printing press, without the hassle of hot foil dies and stamping. The substrate sheet to be enhanced has the UV varnish applied and is then passed through two rollers, the top one with the metal foil, and material job pressed into position to give a hot foil finish. It is possible to adjust the height of the varnish to achieve the embossed effect as well as the foil finish.

After curing the UV varnish printed thick on the substrate surface by screen printing, a hot foil stamping machine can handle the process of thermo-compressing the foil material to the varnish coating area in one pass. This makes it possible to improve productivity by enabling screen printing and hot foil technology in one system. Realizing high quality and high added value by forming the shape with thick UV varnish for screen printing and combining the foil. High accuracy registration can be accomplished because the foil has functionality and can be put on the whole surface or through multiple impositions.

Reference is made to: https://printbusiness.co.uk/news/Sakurai-introduces-inline-foiling-to-screen-print-embellishment/113676/

Full Face Holographic Laminates

Formulated films and foils which are decorative in nature and add security and lasting durability to transaction cards also known as holofoils with vacuum deposited metal are laminated to a plastic core to produce a metallized card body. Holographic imagery and artwork can also be registered within the laminate. Reference is made to U.S. Pat. No. 7,544,266 and https://www.cfcintl.com/productInfo asp?productLineID=1&productID=3

Holofoil

Holofoil (plural holofoils) is a holographic foil or film that displays a holographic image in natural light. The material is used in a wide range of card products including credit cards, debit cards, ATM cards, gift cards, security cards and identification cards, from tamper-evident signature panel, magnetic stripe and scratch-off foils to full face holographic laminates with the holographic imagery and artwork within the laminate. The foils are not only decorative in nature; they also add security and lasting durability to transaction cards. Reference is made to U.S. Pat. No. 7,544,266.

Security Hologram

An interference pattern on a metal foil formed by means of a coherent light source such as a laser. When illuminated the pattern on the metal foil displays a three-dimensional image. The hologram assembled to a plastic card body provides increased anti-counterfeiting security to a debit or credit card.

Kinegram Foil Element

A kinegram foil element is a metallized diffractive security foil similar in appearance to a hologram. During the foil production process, a thin layer of aluminum is vacuum-evaporated onto a carrier material. Before the metallization, the diffractive image is embossed into the material. The silver colored aluminum makes the diffractive image visible. Partial removal of the aluminum layer allows for intricate design elements, such as micro-texts or small images, to be isolated from the main design area. Multiple colors can be added to enhance the diffractive elements in a partially metallized foil. Metallic designs and patterns with an extremely high line resolution of below 10 microns can be created. A kinegram is hot-stamped to a plastic smartcard as an additional level of security and authentication. Reference is made to U.S. Pat. No. 10,427,446.

Bubblegram

A “bubblegram”, also known as laser crystal, 3D crystal engraving or vitrography, is a solid block of glass or transparent plastic that has been exposed to laser beams to generate three-dimensional designs inside. The image is composed of many small points of fracture or other visible deformations and appears to float inside the block.

Lamination Inks

Inks for depositing on transaction cards can be divided into solvent based inks, water based inks, UV screen inks, UV offset inks, signature panel inks, security and special effect inks (UV luminescent inks (responding to exposure to UV radiation or black light (365 nm), UV fluorescing inks, dazzle/sparkle inks, multicolor reflective surface inks, optichromic inks, IR blocking inks, photochromic inks, phosphorescent inks, thermochromic inks and barcode blocking inks) and varnishes. Reference is made to: www.apollocolours.co.uk

Digital Printing of Ultra-Violet Ink

UV printing is a form of digital printing that uses ultra-violet light to dry or cure ink as it is printed. As the printer distributes ink on the surface of a material (called a “substrate”), specially designed UV lamps follow close behind, curing—or drying—the ink instantly. A primer coat may be used to prime the substrate surface to enhance adhesion.

UV flexible ink is a liquid which consists of monomers, colorant, additives, photoinitiator and stabilizer. UV hard ink comprises for example of the following elements: acryl acid ester, 1,6-hexanediol diacrylate initiator, additive and quinacridone series pigment. The primer is made up of aliphatic monomer, acrylic oligomer, aromatic monomer, additives and photoinitiator.

Laser Engravable Overlay Films

Overlay films for smartcards and security documents have been documented under the trademark “Pentacard” which include:
Pentacard PVC (25-100 μm);
Pentacard kplonglife PVC/PET (100 μm); and
Pentacard PETG (50 μm, 100 μm and 150 μm);

In which all overlay films (PVC, PET and PETG) are laser engravable.

Further the overlay products could also include:
Coated and uncoated surfaces;
Adhesion to UV, oxidative, digital, or silkscreen inks;
Various adhesive coatings;
Thermo-printable and laser engravable
Compatible with foil-card applications

Reference is made to the 2012 Brochure of Klöckner Pentaplast: https://www.kpfilms.com/en/Products_Solutions/_Documents/Pentacard_Brochure_2.20.12.pdf

Amorphous Laser Reactive Copolymer (APET)

Amorphous polyethylene terephthalate (APET) contains the same polyester makeup as PET plastic but refers to the specific stage at which the material is still amorphous before molding. The copolymer may be an amorphous polyethylene terephthalate (APET) or any like thermoplastic polymer resin of the polyester family

An amorphous polyethylene terephthalate (APET) laser reactive copolymer layer has a glass transition temperature, Tg, and a melting temperature, Tm, and is characterized in that; (a) it enters a crystalline state and is then settable (thermosetting state) to a set form when its temperature is above its Tg and below its Tm; (b) information or a design can be laser engraved on or within the layer; and (c) the color of the layer can be altered with a laser.

The copolymer is stiffer than PVC and can be thermally set into the desired pattern. When set it exhibits and maintains a scratch resistant property. As stipulated in the prior art (U.S. Pat. No. 9,390,363) the amorphous PET laser reactive copolymer layer is the outer layer of the transaction card.

Tritan™

It is amorphous co-polyester which contains a mold release derived from vegetable-based sources. Its features are excellent toughness, hydrolytic stability, and heat and chemical resistance. This co-polyester can be molded into various applications without incorporating high levels of residual stress. Reference is made to: https://www.eastman.com/Pages/ProductHome.aspx?product=71070312

Polycarbonate Films (PC)

They are a group of thermoplastic polymers containing carbonate groups in their chemical structures. PC is a glassy polymer of relatively high thermal and mechanical stability, and is a good amorphous film for electronic identification cards.

PETG Film

PETG or PET-G (Polyethylene terephthalate glycol-modified) is a clear amorphous thermoplastic that can be injection molded, sheet extruded or extruded as filament for 3D printing.

Polyvinyl Chloride (PVC) Laser Reactive Film

A synthetic thermoplastic material (amorphous polymer) made by polymerizing vinyl chloride. The properties depend on the added plasticizer. The thermoplastic layer in a transaction card may contain or support an integrated circuit chip. Reference is made to: https://www.spirol.com/library/sub_catalogs/ins-Plastic_Overview_us.pdf

Embossed Lamination Plates

These are patterned lamination plates for the production of secure documents such as passports, driving licenses, national ID's and bank cards with integrated security features. The thickness of the plates is usually 0.8 mm with a core hardness of approx. 400 HV. Reference is made to the 2012 website of VTT GmbH: https://www.vtt.de/imprint-impressum.html and the lamination plate solutions from 4Plate: www.4plate.de

Photo Chemical Etching of Metal

Chemical etching is a subtractive sheet metal machining process which uses chemical enchants to create complex and highly accurate precision components for industrial applications from almost any metal.

The chemical etching process works:
By laminating sheet metal with a light-sensitive photoresist which is exposed with UV-light to transfer the CAD image of the component;
The areas of unexposed photoresist are removed (developed), then sprayed with etchant chemistry to accurately remove the unprotected material;
The remaining photoresist is removed (stripped) to reveal the final etched component.

Reproducible superfine structures can be etched into thin metal foils (25 μm) or metal layers (>50 μm) of stainless steel used in the stack-up construction of a metal transaction card, clean, burr- and stress-free. Special metals and alloys such as titanium, gold, molybdenum can also be precision etched. The pattern can be regarded as embossed or debossed.

Polylactide (PLA)

Polylactic acid or polylactide is a thermoplastic aliphatic polyester derived from renewable resources, such as corn starch, tapioca roots or sugar cane, unlike other industrial materials made primarily from petroleum. Due to its more ecological origins this material has become popular within the 3D printing industry.

PLA was created in the 1930s by the American chemist Wallace Carothers, most recognized for the development of nylon and neoprene in the chemical company DuPont. But it wasn't until the 1980s that PLA was finally produced for use by the American company Cargill.

This thermoplastic polymer is produced by fermenting a carbohydrate source such as corn starch. In this case, the natural product is ground to separate the starch from the corn, mixing it with acid or lactic monomers. With this mixture the starch is broken into dextrose (D-glucose) or corn sugar. Finally, glucose fermentation produces L-lactic acid, the basic component of PLA. This material is considered a non-Newtonian pseudoplastic fluid. This means that its viscosity (flow resistance) will change depending on the stress to which it is subjected. Specifically, PLA is a fine cut material, which means that the viscosity decreases as you apply stress.

PLA polymers range from amorphous glassy polymer to semi-crystalline and highly crystalline polymer with a glass transition of 60° C. and melting points of 130-180° C. The basic mechanical properties of PLA are between those of polystyrene and PET.

Several technologies such as annealing, adding nucleating agents, forming composites with fibers or nano-particles, chain extending and introducing crosslink structures have been used to enhance the mechanical properties of PLA polymers. Polylactic acid can be processed like most thermoplastics into fiber (for example, using conventional melt spinning processes) and film. With high surface energy, PLA has easy printability which makes it widely used in 3-D printing.

PLA filament has gained wide acceptance within additive manufacturing partly because it is made from renewable products and also because of its mechanical properties. It is used as a feedstock material in desktop fused filament fabrication 3D printers (e.g. RepRap).

3D Printing Process

It is an additive manufacturing process which builds a three-dimensional object from a computer-aided design (CAD) model, usually by successively adding material layer by layer, unlike conventional machining, casting and forging processes, where material is removed from a stock item (subtractive manufacturing) or poured into a mold and shaped by means of dies, presses and hammers. One of the key advantages of 3D printing is the ability to produce very complex shapes or geometries, and a prerequisite for producing any 3D printed part is a digital 3D model or a CAD file.

Carbon Fibers

Carbon fibers (alternatively CF or graphite fiber) are fibers about 5-10 micrometers (μm) in diameter and composed mostly of carbon atoms. Carbon fibers have several advantages including high stiffness, high tensile strength, low weight, high chemical resistance, high temperature tolerance and low thermal expansion.

To produce a carbon fiber, the carbon atoms are bonded together in crystals that are more or less aligned parallel to the long axis of the fiber as the crystal alignment gives the fiber high strength-to-volume ratio. Several thousand carbon fibers are bundled together to form a tow, which may be used by itself or woven into a fabric.

Carbon fibers are usually combined with other materials to form a composite. When impregnated with a plastic resin and baked, it forms carbon-fiber-reinforced polymer (often referred to as carbon fiber) which has a very high strength-to-weight ratio, and is extremely rigid although somewhat brittle. Carbon fibers are also composited with other materials, such as graphite, to form reinforced carbon-carbon composites, which have a very high heat tolerance.

Glass Fiber

Glass fiber is a material consisting of numerous extremely fine fibers of glass. Glass fiber has roughly comparable mechanical properties to other fibers such as polymers and carbon fiber. Although not as rigid as carbon fiber, it is significantly less brittle when used in composites. Glass fibers are therefore used as a reinforcing agent for many polymer products; to form a very strong and relatively lightweight fiber-reinforced polymer (FRP) composite material called glass-reinforced plastic (GRP), also popularly known as “fiberglass”.

Digital Reverse UV Printing on Overlay Material

Instead of printing directly onto a front or rear face plastic layer (typically PVC with a thickness of 125 μm) in a card body construction, and usually said printed layer is protected by an anti-scratch overlay layer (typically a transparent foil with a thickness of 50 μm), the graphics are digitally printed on the reverse side of the overlay layer using a CMYK digital color process.

Laser Engraving

Laser engraving or laser etching is a subtractive manufacturing process, using a laser beam to engrave alphanumeric and graphic characters (indicia such as a payment scheme logo) into a coated or uncoated metal surface on the front or rear face of a metal card body. The metal card may also have a print layer (ink or paint) applied to its exposed metal surface which may be photo-ablated during laser treatment. The ink or paint layer may be baked on.

Laser Marking

Laser marking, on the other hand is a broader category of laser personalization, leaving marks or intended cardholder data on a front face metal layer of a card body (coated or uncoated) or on a rear laserable synthetic layer. It may also include color change due to photochemical/molecular alteration and oxidation.

Thin Film Interference

This occurs when light waves reflecting off the top and bottom surfaces of a thin film interfere with one another.

Ink

Ink is a pigment (or dye)-based fluid used to color a metal surface to produce an image, text, or graphic design. CMYK inks are typically deposited on a metal surface using digital printing techniques.

Paint

Paint is a liquid or paste that dries into a solid coating, protecting or adding color to a metal surface to which it has been applied, usually by means of a roller coating machine or silk screen printer. Paint is also made to apply in thicker coats than ink. With paint, the pigment particles are usually surrounded by the medium, such as oil, acrylic, polyurethane or other resins. The pigment particles in ink are typically not enveloped by the medium. Paint is a synonym of ink.

Varnish and Ink

Varnish is a clear transparent hard protective finish or film. Varnish has little or no color and has no added pigment. Varnish finishes are usually glossy but may be designed to produce satin or semi-gloss sheens by the addition of “flatting” agents.

The term “varnish” refers to the finished appearance of the product. It is not a term for any single or specific chemical composition or formula. There are many different compositions that achieve a varnish effect when applied. A distinction between spirit-drying (and generally removable) “lacquers” and chemical-cure “varnishes” (generally thermosets containing “drying” oils) is common, but varnish is a broad term historically and the distinction is not strict.

Varnish is essentially ink without pigment and is available in many finishes including gloss, satin and dull. When applied in-line using a regular ink unit in the press, varnish can achieve exact dot-for-dot registration. Varnish manipulates how light reflects or is adsorbed into a sheet. Gloss varnish deepens colors while satin and dull finishes reduce contrast between colors.

In the smartcard industry, protective varnish has a viscosity η under 1000 Pascal-second (Pa·s) and is applied with a roller coater, while protective ink is applied by silk screen printing.

Polymeric Coating

Polymeric coatings are coatings or paint made with polymers that provide superior adherence and protection from corrosion and abrasion. A polymer is a molecule made from joining together many small molecules called monomers. The polymeric coating process applies an elastomeric or other polymeric material onto a supporting substrate such as metallic surface. Examples of polymeric coatings include:
Natural and synthetic rubber
Urethane
Polyvinyl chloride
Acrylic, epoxy, silicone
Phenolic resins
Nitrocellulose

Coating Systems

Basically, coatings consist of solvents (including diluents and some additives) and solids (resins, pigments, extenders, and some additives). Resins (or binders) are polymeric materials which form the bulk of the dried film or layer on a metal surface and give the film or layer its physical properties such as hardness, flexibility, and chemical resistance. Pigments are small particles which give the film or layer color, hiding power and other properties. Extenders are inexpensive thickening agents. Additives are chemicals added to achieve very specialized effects, such as dryers, flattening agents, flowing agents, defoamers, etc.

RFID Slit Technology

Providing a metal layer in a stack-up of a card body, or an entire metal card body, to have a module opening for receiving a transponder chip module (TCM) and a slit (S) to improve contactless (RF) interface with the card—in other words, a “coupling frame”—may be described in greater detail in U.S. Pat. Nos. 9,475,086, 9,798,968, and in some other patents that may be mentioned herein. In some cases, a coupling frame may be formed from a metal layer or metal card body having a slit, without having a module opening. A typical slit may have a width of approximately 100 μm. As may be used herein, a “micro-slit” refers to a slit having a smaller width, such as approximately 50 μm, or less.

“RFID Slit Technology” refers to modifying a metal layer (ML) or a metal card body (MCB) into a so-called “antenna circuit” by providing a discontinuity in the form of a slit, slot or gap in the metal layer (ML) or metal card body (MCB) which extends from a peripheral edge to an inner area or opening of the layer or card body. The concentration of surface current at the inner area or opening can be picked up by another antenna (such as a module antenna) or antenna circuit by means of inductive coupling which can drive an electronic circuit such as an RFID chip attached directly or indirectly thereto. The slit may be ultra-fine (typically less than 50 μm or less than 100 μm), cut entirely through the metal with a UV laser, with the debris from the plume removed by ultrasonic or plasma cleaning. Without a cleaning step after lasing, the contamination may lead to shorting across the slit. In addition, the slit may be filled with a dielectric to avoid such shorting during flexing of the metal forming the transaction card. The laser-cut slit may be further reinforced with the same filler such as a resin, epoxy, mold material, repair liquid or sealant applied and allowed to cure to a hardened state or flexible state. The filler may be dispensed or injection molded. The term “slit technology” may also refer to a “coupling frame” with the aforementioned slit, or to a smartcard embodying the slit technology or having a coupling frame incorporated therein.

### SUMMARY

The invention may relate to innovations in or improvements to RFID-enabled foil composite metal smartcards or metal transaction cards.

The invention may relate to innovations in or improvements to RFID-enabled metal-containing transaction cards.

The invention may relate to innovations in or improvements to RFID-enabled metal-containing transaction cards with a composite layer of fibrous material.

It is an object of the invention(s), as may be disclosed in various embodiments presented herein, to provide improvements in the manufacturing, performance and/or appearance of smartcards (also known as transaction cards), such as metal transaction cards and, more particularly, to RFID-enabled smartcards (which may be referred to herein simply as “cards”) having at least contactless capability, including dual interface (contactless and contact) smartcards, including cards having a metal layer in the stackup of their card body, and including cards having a card body which is substantially entirely formed of metal (i.e., a metal card body).

An object of the invention is to produce an RFID-enabled metal transaction card whose planar front and rear surfaces as well as its edges are prepared with visual and tactile characteristics which bestow a degree of prestige to the cardholder. Special textures on the outer surface or surfaces of a card body may enhance the haptic touch of the card body, but at the same time operate as an antenna to permit radio frequency reception and transmission.

It is an object of the invention to assemble a hologram foil directly to a metal layer with a micro-slit, or an ink coated metal layer with a micro-slit.

It is an object of the invention to assemble a hologram directly to a hard coat layer which scratch protects the underlying baked-on-ink layer applied to a metal layer with a micro slit or slits.

It is an object of the invention to deposit a very thin layer of metal at, around, or over a micro-slit in a metal layer.

It is an object of the invention to make a card that is virtually impossible to alter, without destroying the appearance of the card, or that the alteration is very easily detectable.

It is an object of the invention to produce RFID-enabled metal transaction cards with a composite layer of carbon fiber for use in the payment industry.

It is an object of the invention to provide an RFID-enabled metal transaction card having a carbon fiber structure which has an aesthetically unique appearance, as well as extreme durability.

According to the invention, generally, RFID-enabled composite metal transaction cards include a security layer comprising a hologram or diffraction grating assembled to or formed on a metal layer disposed with a discontinuity (slit). The metal layer may reside on a front or rear face, or as a core layer in the construction of a metal transaction card.

The security layer, with or without a carrier layer, may be hot stamped to a metal layer with a protective hard coating, to camouflage the existence of a discontinuity in the metal layer. Prior to applying the security layer, the metal layer with slit or slits is coated with a baked-on-ink to provide color and to partially fill the slit or slits.

The security layer may camouflage or cover entirely or partially the discontinuity in the metal layer.

The security layer may be a metal foil on a carrier material, a metal foil without a carrier material, or a very thin layer of metal deposited or grown on or over a discontinuity in a metal layer.

The security layer may be non-conductive and electromagnetic transparent to ISM frequency bands.

The security layer without a carrier layer may be spot or laser welded directly to a metal layer.

The security layer with or without a carrier layer may be hot stamped to a metal layer with a protective hard coating, to camouflage the existence of a discontinuity in the metal layer.

The security layer on a composite metal transaction card may be laser processed to produce desired alpha numeric information, bar code information or a graphic image during personalization of the card.

A textured conductive foil in any color may be applied to the outer surface of a metal transaction card, with its conductive metal surface acting as an antenna or coupling frame to drive a transponder chip module. The conductive foil may be laser etched to create additional decorative designs or security features. The metal foil may adhere to a cured screen-printed UV varnish applied to the card body or to an array of card body sites (inlay), and depending upon the design, can achieve flat, tactile or 3D effects. The design of the coupling frame may be integrated into the decorative areas, and all the details from the screen are printed with a UV varnish and covered by the foil.

The foil may camouflage a slit in an underlying metal layer. The UV varnish may be screen printed directly to metal or to a synthetic layer in the metal transaction card.

A metal foil, holofoil or a holographic metal film (hot stamped, laminated, or pre-applied on a synthetic substrate to a card body or to an array of card bodies) may be provided with a discontinuity in the form of a slit to act as a coupling frame in order to facilitate contactless communication. The foil may be a decorative foil mounted to a card body containing a metal layer with a slit.

A hologram or diffraction grating may be disposed on a metal foil or on a very thin metal layer which is formed or grown at the designated area on the metal layer.

A security layer, with or without a carrier layer, may be mounted or assembled directly to a designated area on the metal layer by means of hot stamping, spot or laser welding.

Texture or an emboss/deboss effect on a card body or on an array of card bodies may be achieved with 3D printing of a thermoplastic polymer such as Polylactide (PLA)

3D printing of conductive surfaces and circuits with a conductive thermoplastic filament may be used to fabricate a coupling frame in a transaction card.

An RFID-enabled metal transaction card comprising at least one metal layer having a slit to function as a coupling frame and attached to at least one layer of fibrous material, such as carbon fiber strands or filaments woven for example in a weave pattern. The carbon fiber layer may be sandwiched between two metal layers with a slit, forming a metal face card. Alternatively, a metal layer with slit may be sandwiched between two carbon fiber layers, forming a metal core card. The carbon fiber layers may be laminated with an adhesive layer on each of two opposing faces of the metal layer. An over-laminate film (overlay) such as a transparent polyvinyl chloride plastic film (with the option of laser engraving) or a hard coat layer on a release carrier layer may be laminated on each of the two opposing faces of the transaction card core.

According to some embodiments (examples) of the invention, an RFID-enabled smartcard comprises:
a metal layer having a scratch protection coating over a print layer on its front face, wherein the scratch protection coating comprises one or the other of (i) a layer of ink, varnish or a polymer and (ii) a layer of hard coat lamination film;
wherein the scratch protection coating is suitable for one or more of the following treatments:
the scratch protection coating is capable of being laser marked for inscribing personalization data into or onto the coating;
the scratch protection coating is capable of being laser engraved to partially remove the coating in creating a logo or a deboss feature; and
the scratch protection coating is capable of being laser treated without removal of material to create thin film effects.
The metal layer may also be laser marked or laser engraved.
A laser for performing the laser marking, engraving or treatment may have a wavelength in the UV, IR or visible, and may have a varying pulse width in the nanosecond, picosecond or femtosecond regime.

According to some embodiments (examples) of the invention, a multi-layered composite metal transaction card may comprise:
a plastic layer having top and bottom surfaces attached to a metal layer; and
a metal layer with a discontinuity in the form of a micro-slit at a designated area with said metal layer residing at the front face, rear face or at the core of the transaction card;
wherein a security layer is assembled to or formed on the designated area of the metal layer with said security layer camouflaging or covering the discontinuity; and
wherein said metal layer acts as a radio frequency antenna and the security layer does not attenuate the field.

The security layer may be electromagnetically transparent.

The security layer may comprise a hologram or diffraction grating on a metal foil or on a very thin metal layer formed or grown at the designated area on the metal layer.

The security layer may comprise an embossed or debossed pattern.

The security layer, with or without a carrier layer, may be mounted or assembled directly to a designated area on the metal layer by means of hot stamping, spot or laser welding.

The metal transaction card may further comprise:
a plastic layer, which may be a clear plastic layer attached to the metal layer, having information selectively written thereon; and
at least one window or opening formed within the plastic layer to enable visibility of the hologram or diffraction grating on the security layer.

According to some embodiments (examples) of the invention, a metal face transaction card may comprise:
a transaction card structure comprising a layer or layers of metal with a slit; and
a plastic layer or a combination of plastic layers laminated on one of the two opposing faces of the metal layer or layers to form an RFID-enabled metal transaction card body;
wherein the layer of metal of the transaction card comprises a decorative metal foil layer on a UV screen printed layer;
wherein the decorative metal foil layer has a discontinuity to act as a coupling frame in order to power a transponder chip module; and
wherein the decorative metal foil layer imparts texture to the card body surface.

The discontinuity may be an integral part of the decorative metal foil pattern.

The metal foil layer may comprise laser etched elements for design and alphanumeric information of a cardholder.

The metal foil layer may have multiple colors and design patterns.

The plastic layer or a combination of plastic layers capture a magnetic stripe and security elements (signature panel and hologram) and may be protected by a laser engravable overlay layer.

According to some embodiments (examples) of the invention, a metal face transaction card may comprise:
a layer or layers of metal with a slit; and
a plastic layer or a combination of plastic layers laminated on one of the two opposing faces of the metal layer or layers to form an RFID-enabled metal transaction card body;
wherein the layer of metal of the transaction card comprises a decorative metal foil layer on a UV screen printed layer;
wherein the decorative metal foil layer may regulate the system frequency of the combined operation of the transponder chip module and the metal layer or layers with a slit acting as a coupling frame; and
wherein the decorative metal foil layer imparts texture to the card body surface and camouflages a slit or slits in the underlying metal layer or layers.

According to some embodiments (examples) of the invention, a metal core transaction card with 3D printing graphic surface, may comprise a stack-up construction of the following layers, from top (front) to bottom (rear):
a front protective film layer,
a front substrate layer,
an intermediate metal layer with slit,
a rear substrate layer,
a rear printing graphic layer,
a rear protective film layer,
and may be characterized in that:
an upper surface of said front protective film layer is adhered to what? with a 3D printed graphic conductive layer to act as a coupling frame.

A concave cavity or pocket for accommodating a transponder chip module may be formed on the stack-up construction, with the transponder chip module overlapping the 3D printed graphic conductive layer.

According to some embodiments (examples) of the invention, a smartcard may comprise:
a first metal layer having two sides and a slit to function as a coupling frame; and
a first composite layer of fibrous material disposed on one side of the first metal layer. The metal layer may have an opening for a transponder chip module.

The smartcard may further comprise:
a second composite layer of fibrous material disposed on the other side of the first metal layer, thereby sandwiching the metal layer between the two composite layers.

The smartcard may further comprise:
a second metal layer having two sides and a slit to function as a coupling frame;
wherein:
the first composite layer is sandwiched between the two metal layers.

According to some embodiments (examples) of the invention, a method of making an RFID-enabled metal transaction card, may comprise:
providing a composite layer of fibrous material arranged in a certain pattern;
enclosing the composite layer of fibrous material at least in part on each side by a metal layer with a slit acting as a coupling frame to form a card core; and FIG. 4
laminating an over-laminate film or a hard coat film layer on each of two opposing faces of the card core.

The over-laminate film may comprise a transparent film which is laser engravable.

The composite layer of fibrous material may comprise:
fiber strands or filaments selected from the group consisting of mineral fiber strands or filaments, glass fiber strands or filaments, metal fiber strands or filaments, and polymer fiber strands and filaments in a certain pattern.

Enclosing the composite layer of fibrous material between the two metal layers with a slit to form the card core further may comprise:
enclosing the composite layer of fibrous material at least in part on each side by an adhesive film comprising a material selected from the group consisting of polyethylene, acrylic, cyanoacrylate, and epoxy.

At least one of the two opposing faces of the transaction card core may be printed.

According to some embodiments (examples) of the invention, a method of making an RFID-enabled metal transaction card may comprise:
providing a metal core layer with a slit acting as a coupling frame;
enclosing the metal core layer with a slit at least in part on each side by a composite layer of fibrous material to form a card core; and
laminating an over-laminate film on each of two opposing faces of the card core, at least one of the over-laminate films comprising a transparent film which is laser engravable, or alternatively laminating a hard coat film layer on each of two opposing faces of the card core.

According to an embodiment of the invention, a metal foil-based optical security device may be used to cover or camouflage a micro-slit in a metal layer forming part of a transaction card. The metal foil-based optical security device may comprise of a synthetic film or carrier layer attached to a metallic or a high refractive index (HRI) transparent holographic foil.

Accordingly, a composite metal card formed in accordance with the invention includes a security layer formed at or around a micro-slit in a core metal layer or in a front or rear face metal layer, of the card. Composite metal cards embodying the invention may include a hologram or diffraction grating formed at or around a micro-slit or slits in the core metal layer or in a front or rear face metal layer, of the card, with symmetrical synthetic layers formed above and or below the metal layer.

A hologram may be formed by embossing or debossing a designated area of the metal layer with a diffraction pattern using a laser, and further vapor depositing or growing (epitaxial growth) a very thin layer of metal, metal oxide or metal compound on the embossed/debossed layer. The designated area of the metal layer comprises of a micro-slit.

According to an embodiment of the invention, the metal foil forming part of the optical security device assembled to the metal layer with micro-slit or the very thin layer of metal, metal oxide or metal compound vapor deposited or grown on the metal layer with micro-slit, is electromagnetic transparent.

The layer of metal, metal oxide or metal compound deposited or grown on the metal layer may be made to provide a “see-through” effect, under appropriate light conditions. However, where the very thin layer of metal, metal oxide or metal compound deposited or grown on the metal layer is of “standard” thickness”, the pattern may only be seen from a top or side view.

In the case of a metal oxide layer deposited or grown, the metal oxide may be non-conductive.

In addition, the layer of metal, metal oxide or metal compound may be electromagnetically transparent to ISM frequency bands.

After the hologram is formed or assembled on or to the metal layer, a laser may be used to remove selected portions of the metal around the designated area covering or camouflaging the micro-slit to impart a selected pattern, graphic image or information (alpha numeric or bar code) to the holographic region.

The holographic design may also have the appearance of full metal, or partial metal and partial white coverage (white reflecting hologram).

According to an embodiment of the invention, the holographic metal foil with or without the synthetic film or carrier layer may be directly assembled or mounted to a metal layer or metal card body by means of spot or laser welding or ultrasonic bonding.

If a potential counterfeiter attempts to disassemble the composite metal card in order to compromise the integrity of the image or information contained on, or in, the card, it would cause a change in the hologram, resulting in the hologram being irreparably damaged. Therefore, composite metal cards formed in accordance with the invention are truly tamper resistant.

In their various embodiments, the invention(s) described herein may relate to industrial and commercial industries, such RFID applications, payment smartcards (metal, plastic or a combination thereof), electronic credentials, identity cards, loyalty cards, access control cards, and the like.

According to an embodiment of the invention, a textured conductive foil may be applied to the outer surface of a metal transaction card, with its surface acting as an antenna or coupling frame to drive a transponder chip module. Said textured conductive foil may be further laser etched to create additional decorative designs or security features.

The metal foil may adhere to cured screen-printed UV varnish applied to the card body or an inlay sheet with an array of card body sites, and depending upon the design, can achieve flat, tactile or 3D effects.

The design of the coupling frame antenna is integrated into the decorative areas, and all the details from the screen are printed with a UV varnish and covered by the foil.

According to an embodiment of the invention, a metal foil, holofoil or a hologram (hot stamped, laminated, or pre-applied on a synthetic substrate) provided with a discontinuity may act as a coupling frame to facilitate contactless communication. The foil may be a decorative foil mounted to a card body containing a metal layer with a slit.

According to an embodiment of the invention, carbon fiber, leather, textile, stone, wood, glass, ceramic and any decorative or exotic material may be used to fill a recess area or pocket in a metal card body (having a slit) which has been chemically etched or mechanically milled. Further the slit in the metal card body may be camouflaged by said material.

The surface of the metal card body and its perimeter edges may be brushed, sand blasted, coated with sand, or baked with a vibrant color to impart a special appearance or feeling to the metal transaction card. The pre-treated metal transaction card may be laser etched or ablated to reveal the underlying metal, pattern a design or scribe the credentials of the card holder.

Standard card printing technology includes digital and lithographic techniques that delivers CMYK, Spot/Pantone colors, with matt and gloss finishes, as well as the printing of metallic inks to create special effects. Texture or an emboss effect on a card body may be achieved with 3D printing of thermoplastic polymers such as PLA.

According to an embodiment of the invention, 3D printing of conductive surfaces and circuits with conductive thermoplastic filament may be used to fabricate a coupling frame in a transaction card.

According to the invention, generally, an RFID-enabled metal transaction card may incorporate a composite layer of a woven carbon fiber structure into the body of a standard metal credit card with contactless functionality. An RFID-enabled metal transaction card may comprise at least one metal layer having a slit to function as a coupling frame and attached to at least one layer of fibrous material, such as carbon fiber strands or filaments woven for example in a weave pattern.

The carbon fiber layer may be sandwiched between two metal layers with a slit, forming a metal face card.
Alternatively, a metal layer with slit may be sandwiched between two carbon fiber layers, forming a metal core card. The carbon fiber layers may be laminated with an adhesive layer on each of two opposing faces of the metal layer. An over-laminate film (overlay) such as a transparent polyvinyl chloride plastic film (with the option of laser engraving) or a hard coat layer on a release carrier layer may be laminated on each of the two opposing faces of the transaction card core.
The carbon fiber layer(s) may facilitate the retention (or improving) of the “drop acoustics” of the card.

According to some embodiments of the invention, a method of making an RFID-enabled metal transaction card may comprise:
providing a metal core layer with a slit acting as a coupling frame;
enclosing the metal core layer, at least in part, on each side thereof, by a composite layer of fibrous material to form a card core; and
laminating an over-laminate film on each of two opposing faces of the card core, at least one of the over-laminate films comprising a transparent film which is laser engravable, or alternatively laminating a hard coat film layer on each of two opposing faces of the card core.

According to some embodiments of the invention, a method of making an RFID-enabled metal transaction card may comprise:
providing a composite layer of fibrous material arranged in a certain pattern;
enclosing the composite layer of fibrous material on both sides by a metal layer with a slit acting as a coupling frame to form a transaction card core;
laminating an over-laminate film on each of two opposing faces of the card core (metal/composite layer/metal), at least one of the over-laminate films comprising a transparent film which is laser engravable, or alternatively laminating a hard coat film layer on each of two opposing faces of the card core.

The over-laminate film(s) may be transparent, and may be referred to as “overlay layer(s)”.

According to a feature of the invention, the overlay layer(s) may be reverse digitally printed.

According to some embodiments of the invention, RFID-enabled metal transaction cards may be produced by the methods disclosed herein.

Additional objects, advantages and features of the invention will be set forth in part in the description which follows, and in part will become more apparent to those skilled in the art upon examination of the following, or may be learned by practice of the invention.

In their various embodiments, the invention(s) described herein may relate to industrial and commercial industries, such RFID applications, payment transaction cards (metal, ceramic, plastic or a combination thereof), electronic credentials, identity cards, loyalty cards, access control cards, wearable devices, and the like.

Other objects, features and advantages of the invention(s) disclosed herein may become apparent in light of the following illustrations and descriptions thereof.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be stylized, simplified or exaggerated, others may be omitted, for illustrative clarity.

Although the invention is generally described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

Some elements may be referred to with letters (“AS”, “CBR”, “CF”, “MA”, “MT”, “TCM”, etc.) rather than or in addition to numerals. Some similar (including substantially identical) elements in various embodiments may be similarly numbered, with a given numeral such as “310”, followed by different letters such as “A”, “B”, “C”, etc. (resulting in “310A”, “310B”, “310C”), and may collectively (all of them at once) referred to simply by the numeral (“310”).

FIG. 1 (compare FIG. 1 62/946,990; and FIG. 1 of U.S. Pat. No. 9,390,363) is a cross sectional diagram of the layers of a subassembly of a card, according to the prior art.

FIG. 1A (compare FIG. 1A 62/946,990; and FIG. 1A of U.S. Pat. No. 9,390,363) is a cross sectional diagram of the layers of another subassembly, according to the prior art.

FIG. 1B (compare FIG. 1B 62/946,990; and FIG. 1B of U.S. Pat. No. 9,390,363) is a cross sectional diagram of the layers of the card of FIG. 1A being laser engraved, according to the prior art.

FIG. 2 (compare FIG. 2 of 62/911,236; and FIG. 9 of U.S. Pat. Nos. 10,373,920 and 10,332,846) is a cross sectional diagram of a dual interface card, according to the prior art.

FIG. 3 (compare FIG. 1 of 62/933,526; and FIG. 4 of U.S. Pat. No. 9,646,234) is a cross-sectional view of an example of a carbon fiber substructure sandwiched between two layers of clear PVC plastic of the inner core over-laminated with clear PVC plastic film for a transaction card, according to the prior art.

FIG. 4 (compare FIG. 4 of 62/911,236) is a diagram (perspective view) of a transaction card including a holographic portion, according to an aspect or embodiment of the invention.

FIG. 5 (compare FIG. 5 of 62/911,236) is a diagram (in cross-section) detailing an example of some of the steps in forming a transaction card, according to an embodiment of the invention.

FIG. 6A (compare FIG. 2 of 62/946,990) is a simplified plan view diagram of a metal transaction card with a recess to accommodate a carbon fiber layer camouflaging a slit in a metal layer or in a metal card body, according to an embodiment of the invention.

FIG. 6B is a perspective view diagram of a metal transaction card with a recess to accommodate a carbon fiber layer with an opening for an inductive coupling chip module (ICM), with the carbon fiber camouflaging the slit in the metal layer or in the metal card body, according to an embodiment of the invention.

FIG. 7A (compare FIG. 3 of 62/946,990) is a perspective view of a card embodying the invention showing a metal foil being applied to a transaction card, according to an embodiment of the invention.

FIG. 7B is a perspective view of a card embodying the invention showing a metal foil with a slit for texturing the surface of a metal card body (MCB) and the production steps in applying the foil to the card body, according to an embodiment of the invention.

FIG. 8A (compare FIG. 2 of 62/933,526) is a perspective partially cut-away view of an example of a metal core layer with slit (not shown) to function as a coupling frame sandwiched between two layers of carbon fiber structure for a metal transaction card, according to an embodiment of the invention.

FIG. 8B is a perspective partially cut-away view of an example of a metal core layer with slit to function as a coupling frame sandwiched between two layers of carbon fiber structure for a metal transaction card, according to an embodiment of the invention.

FIG. 9 (compare FIG. 3 of 62/933,526) is a cross-sectional view of the card 820 shown in FIG. 8B, an example of a metal core layer with slit (not shown) to function as a coupling frame sandwiched between two layers of carbon fiber structure laminated together using adhesive layers for a metal transaction card, according to an embodiment of the invention.

FIG. 10 (compare FIG. 4 of 62/933,526) is a perspective partially cut-away view of an example of a carbon fiber structure sandwiched between two metal layers with one having a visible slit to function as a coupling frame for a metal transaction card, according to an embodiment of the invention.

FIG. 11 is a simplified cross-sectional diagram of a “hybrid” metal card assembly for manufacturing a metal transaction card that can be personalized on the front and rear surfaces using a laser beam, according to an embodiment of the invention.

FIG. 12 is a modification of FIG. 11 illustrating a cross-sectional diagram of a “Metal Face” card assembly with a front-face ink-baked metal surface protected by a hard coat layer for manufacturing a metal transaction card that can be personalized on the front and rear surfaces using a laser beam, according to an embodiment of the invention.

### DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein.

Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

Reference may be made to disclosures of prior patents, publications and applications. Some text and drawings from those sources may be presented herein, but may be modified, edited or commented to blend more smoothly with the disclosure of the present application.

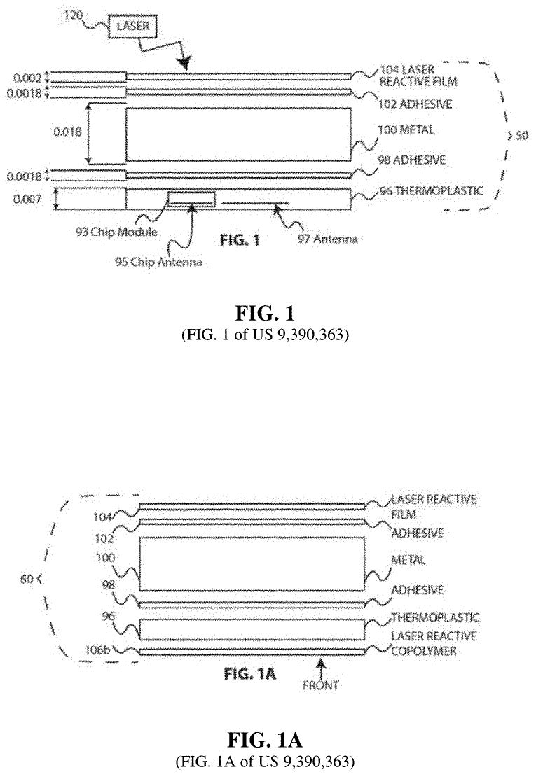

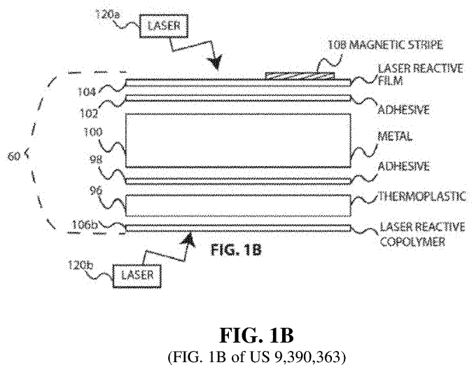

FIG. 1 shows a subassembly 50 which includes a thermoplastic layer 96 over which is located an adhesive layer 98 over which is located a metal layer 100 over which is located an adhesive layer 102 over which is formed a laser reactive film layer 104. The thermoplastic layer 96, also referred to as an inlay, is shown to include a chip module 93 (also denoted as an integrated circuit, IC), a chip antenna 95 coupled to the chip and a booster antenna 97 as shown in greater detail in FIG. 1H. The chip 93 may be mounted on or within layer 96. Layer 96 may be a PVC pigmented (colored) thermoplastic layer having a color selected to be imparted to the card. The adhesive layer 98 is selected to ensure adhesion of layer 96 to the underside of metal layer 100, as shown in FIG. 1. In FIG. 1, the metal layer 100 is shown to be a “thick” metal layer (e.g., 0.0155 inches) and functions as the core layer (or substrate of the card). However, the layer 100 may be much thinner (i.e., it may be a thin foil layer of vapor deposited metal of 10 angstroms thickness) or it may even be thicker up to 0.029 inches. Alternatively, metal layer 100 may be replaced by a plastic layer which includes high density particles which simulate a metal layer. Still further, layer 100 may be a plastic core layer to produce an all plastic card.

The laser reactive film 104 is attached to the topside of metal layer 100, as shown as in FIG. 1. The layer 104 is typically made of polyvinylchloride (PVC) which is a material that is particularly well adapted to printing. Layer 104 is also made laser reactive to enable treatment by a laser to control imparting of information and certain color control. The laser reactive film 104 enables any selected information, pattern or design to be imparted to the laser reactive film 104 via a suitable laser device 120. In the making of cards, the laser reactive film 104 may be selected to have any desired, and/or suitable, color. The selected color will project this coloring to a viewer facing that side of the card. Subassemblies, such as subassembly 50, may be subjected to further processing (e.g., the addition of other layers, lamination, etc.) to form cards having desired qualities and characteristics.

A laser reactive copolymer layer may be attached to the top and/or to the bottom of subassembly 50.

FIG. 1A shows that the subassembly 50 can be modified with the addition of a laser reactive copolymer layer 106b underlying layer 96 (in FIG. 1A) to form a subassembly 60. Actually, layer 106b is normally intended to be, and function as, the front of the card. Note also that a magnetic stripe 108 is typically attached to the back of the card (on top of layer 104 in FIG. 1B).

The introduction of the laser reactive copolymer layer 106b provides significant features. The laser reactive copolymer layer 106b is preferably an amorphous thermoplastic polyester plastic material such as polyethylene terephthalate (APET) or any like material. A significant aspect of this amorphous thermoplastic material is that certain of its properties change drastically as it is heated above its glass transition temperature, Tg, and below its melting point temperature, Tm. When heat is applied to the plastic material such that it is at a selected temperature, which exceeds its Tg and is less than its Tm, the plastic material starts to cross link or crystallize and enters a thermosetting state (rather than being a thermoplastic). This means that its external shape cannot be changed without irreversible destruction from the form it assumed when it reached the selected temperature. Thus, the copolymer layer 106b can be heated to a selected temperature within this temperature range (between Tg and Tm) to cause the material to enter a crystalline state and assume a (thermo-) set condition.

The temperature dependent characteristic of the copolymer layer 106b ensures that when the layer 106b is embossed (or debossed) with a pattern at a predetermined temperature (above the glass transition temperature, Tg, of the copolymer and below its melting temperature, Tm) it becomes thermoset, rather than being thermoplastic, and its external shape (the embossed form) cannot be changed from the embossed form to which it was set at the predetermined temperature without destroying the embossed pattern. The resultant embossed pattern is found to be scratch resistant and to mask scratches due to optical light reflectivity of the embossed pattern. The copolymer (e.g., APET) selected for use is stiffer than PVC and can be thermally set into the desired pattern. By way of example, a co-polyester manufactured by Eastman Chemical under the brand name Tritan was used to make some experimental cards.

Another significant aspect of layer 106b is that it is also laser reactive so it can be laser engraved to enable information to be introduced on or within the layer. In addition, the laser reactive property enables the color of the layer to be altered to shades of black or white dependent on laser settings. The laser reactive portion of the copolymer layer enables virtually any desired information or design to be laser engraved on or within the layer and to also alter the color of the layer.

FIG. 1 shows that the laser reactive copolymer layer 106b and the laser reactive film 104 may be operated upon (treated) by a suitable laser device 120a and/or 120b to form any design or pattern so the layers 106b and 104 can contain any desired information. The laser reactive copolymer layer 106b (as well as layer 106a discussed below) includes silicon and carbon particles. Applicants discovered that by controlling the power and wavelength of the lasering device (e.g., 120a, 120b) directing their energy onto the laser reactive copolymer layers 106a and/or 106b the color of the layers could be controlled from their native state. The laser reactive copolymer films may be treated with the laser to turn their surface from their native color to black or the layers may also be turned white by changing the selected laser frequency and power settings. This color change can be produced as a gradient, by altering laser power and exposure time. By controlling the color and resultant contrast, a variety of desired images may be produced in the copolymer layers 106a, 106b. The final laser effect (secure, artistic or both) may also be controlled by choosing the correct type of laser such as YAG or CO₂, as well as the pulse rate and speed or combination of laser types. Note that lasers may be used to impart colored personalization, static art or other desired images to the core layer and to other selected layers before or after lamination. The imparting of images may be in the form of laser engraving, oxidizing, pattern annealing, carbon migration, layer removal or any form of laser marking known in the art.

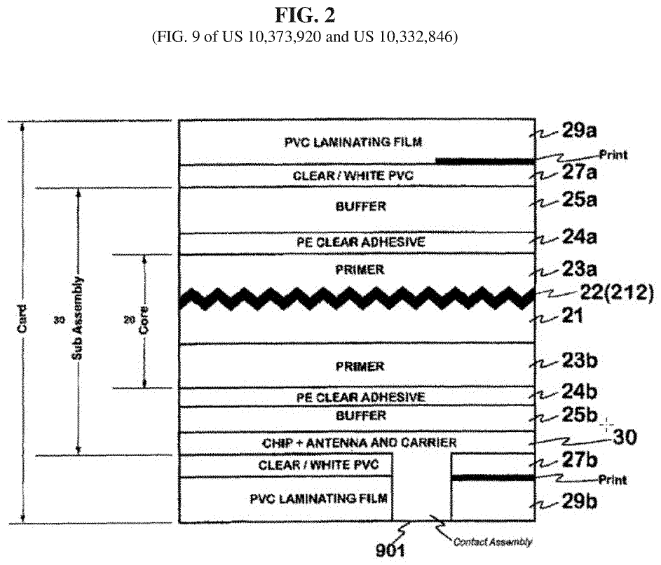

FIG. 2 illustrates that the chip (IC) and an antenna and carrier may be formed within a layer of the card and that in addition, the chip may be accessed (read) by providing an external contact 901 along one side of the card. This type of card may be referred to as a dual interface card since it enables information on the card to be read or written via RFID and contact. Note that the metal layer 22/212 can act as a radio frequency shield to reduce reception from that side of the RFID antenna.

A layer 22 of aluminum (or any suitable metal or metal compound such as Zinc Sulfide) may be vapor deposited on a diffraction pattern to form a hologram. The use of vapor deposition is very significant in that it permits a very thin layer 22, a few atoms thick, to be formed on surface 21a and thus complete the formation of the hologram, using small amounts of metal.

A high refractive index (HRI) layer 212 can be vapor deposited on an embossed layer. Due to the HRI property of layer 212, there is no need to further metallize the layer. The HRI layer may be formed of zinc sulfide or zinc oxide or any material having like properties. Clear primer layer 23a and 23b is attached to the top and bottom of HRI layer 212.

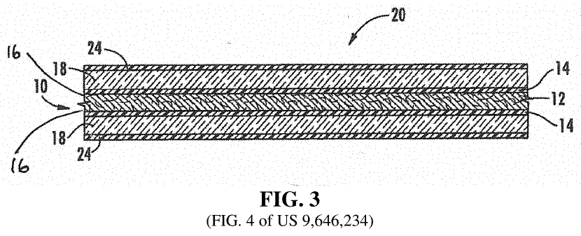

FIG. 3 shows a cross-sectional view of an example of a carbon fiber substructure 10 sandwiched between two layers 18 of clear PVC plastic over-laminated with clear PVC plastic over-laminates 24, for a transaction card 20 such as a credit card.

The carbon fiber substructure 10 comprises carbon fiber strands or filaments which are woven into a weave pattern component 12. The weave pattern component 12 is mounted between two layers 14 of thin clear plastic and adhesive 16, such as clear PVC plastic film. The thin clear plastic layers 14 hold the carbon fibers together and keep the weave pattern 12 of the substructure 10 intact. The adhesive 16 fills the air voids around the carbon fibers and bonds the fibers to the PVC skin 14.

Materials for the carbon fiber substructure 10 include various combinations of substrates such as both amorphous and biaxially oriented forms of polyethylene terephthalate (PET) plastic or combinations of both, polyvinyl chloride (PVC) plastic, other suitable plastics, adhesives such as polyethylene, acrylic, cyanoacrylate, epoxies, and carbon fibers commonly used for extreme durability strength in airplane structures, automotive components, etc.

This specification describes different techniques as embodiments of the invention to camouflage or cover a discontinuity in a metal layer or metal card body by one or more of the following:

(i) applying a hologram on a carrier base layer to an area surrounding a discontinuity and or a module opening;

(ii) laser etching a diffraction grating directly on a metal layer with a discontinuity forming part of the resulting holographic pattern representing a security feature embedded in the card body;

(iii) forming a recess in a front face metal layer to accommodate a carbon fiber layer which covers the surrounding area of the underlying discontinuity; and

(iv) texturing the outer surface of a metal card body with a conductive foil having a discontinuity in the graphical nature of the texture to act as an antenna or coupling frame driving a transponder chip module, with said textured conductive foil laser etched to additionally create decorative designs or security features.

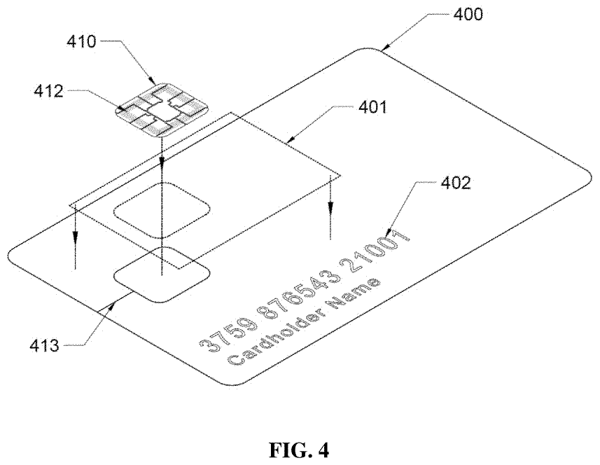

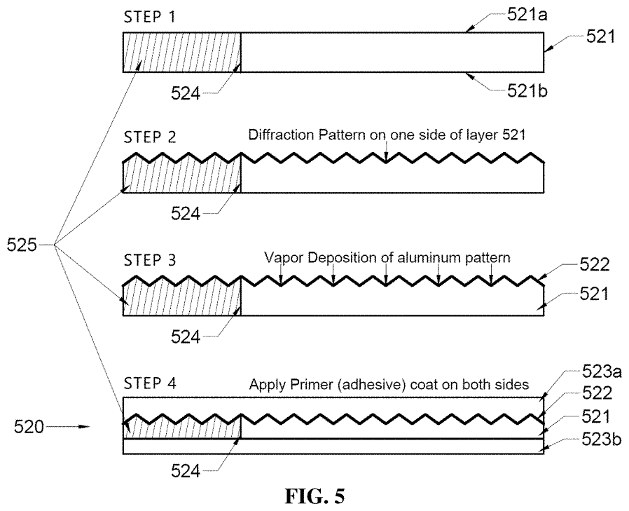

FIG. 4 shows a top view of a metal transaction card 400 illustrating that the hologram may be located within a designated area 401, partially camouflaging or covering a discontinuity 413 in the metal layer forming the card body 400. The hologram surrounds a transponder chip module 410 with a module antenna 412. Alternatively, the hologram may extend the full length and/or width of the card 400, completely camouflaging or covering the discontinuity 413 in the metal layer 400. Note that alpha numeric information may be produced by lasing within the holographic layer. Also, alpha numeric information may be produced by printing information on, or within the synthetic layers attached to the metal layer. The intended cardholder data 402 may also be lasered into a protective cover layer (hard coat layer) laminated to the card body. The hologram may be hot-stamped to the hard-coat layer. Compare FIG. 5 of U.S. Pat. No. 10,373,920.

FIG. 5 shows some steps in a method of forming a transaction card, commencing with a metal core comprising a metal layer 521 with a discontinuity 524 at a designated area 525. The metal layer may comprise stainless steel or any other conductive metals or alloys and/or a combination of these materials.

Step 1

The metal layer 521 is shown to have an upper (top, front) surface 521a and a lower, or bottom, surface 521b. For purpose of illustration, a diffraction pattern to be formed on, or above, surface 521a of layer 521 is shown. However, it should be understood that, alternatively, the diffraction pattern could be formed on surface 521b.

Step 2

The upper surface 521a of layer 521 may be embossed or debossed with a diffractive or holographic pattern using a laser etching technique. The pattern is prepared around the designated area 525 in preparation for camouflaging or covering the discontinuity 524.

Step 3

A layer 522 of aluminum (or any suitable metal, metal oxide or metal compound such as Zinc Sulfide) may then be vapor deposited or grown on the diffraction pattern to form a hologram, which may also be referred to as a security layer.

The use of vapor deposition is significant in that it permits a very thin layer 522, which may be only a few atoms thick, to be formed on front surface 521a and thus complete the formation of the hologram, using small amounts of metal. Using vapor deposition, the thickness of the layer can be made very thin so that it is nearly transparent and can provide a “see-through” effect. Alternatively, the metal layer can be made a little thicker so as to be more opaque.

The very thin layer 522 of metal deposited or grown around the designated area may have a thickness which is electromagnetically transparent to the ISM frequency of 13.56 MHz.

The security feature or layer may be “buried” within the structure of the card, to prevent tampering or alteration. Subsequent layers covering the security feature may be transparent (or have openings/windows) in selected areas so that the security feature is visible from the exterior of the card.

The security layer, with or without a carrier layer, may be mounted or assembled directly to a designated area on the metal layer by means of hot stamping, spot or laser welding. ??

Step 4

A clear adhesive primer layer 523a, may be coated over the patterned and metallized top surface (521a) and a similar clear adhesive primer layer 523b may be coated over the bottom surface (521b) of the layer 521. The core 520 is completed by attaching these clear adhering layers (523a, 523b) above and below the embossed or debossed metal layer 521. The primer coatings 523a, 523b are fairly thin and yet fairly strong and sturdy. They also function to promote adhesion to other synthetic layers which are attached to the core 520.

By forming the hologram at, and within, the core level, the hologram will not be easily, or inadvertently, damaged since several additional layers will be attached to the top and bottom of the holographic layer.

By forming the hologram at, and within, the core level, the hologram is also not subject to easily being tampered or altered. Forming the hologram at the center of the card structure minimizes the possibility of tampering while fully protecting the hologram.

Another significant advantage of forming the hologram at the core of the structure is that the top and bottom surfaces stay flat due to equal shrinking and/or expansion of all the layers.

Note that the card structure may be formed so as to be symmetrical about the core layer—in other words, having similar layers both above and below the core.

Alternatively, a hologram or security layer may be formed by, for example, embossing or debossing a pattern in a carrier base material (e.g., a hard polyester) or by embossing or debossing the pattern in a coating previously applied to the carrier base material, or by embossing or debossing the pattern in a metal which was previously deposited onto the base carrier material or by depositing the metal onto a soft coating and then embossing or debossing.

In the case of a security layer in which the pattern is embossed or debossed in a metal foil on a carrier material, the metal foil may be electromagnetic transparent, and may be assembled directly to the metal layer 521 by means of hot stamping, spot or laser welding. The metal foil may further camouflage or cover the discontinuity 524 at the designated area 525.

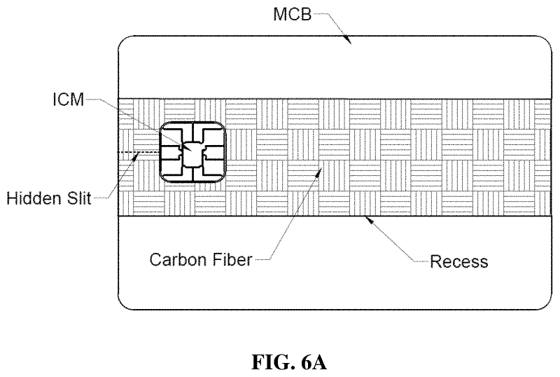

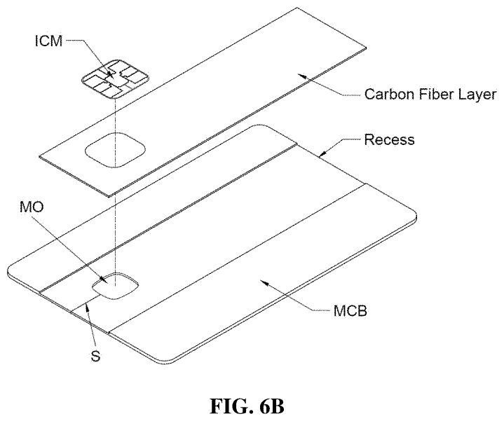

FIG. 6A shows a metal transaction card with a recess to accommodate a carbon fiber layer camouflaging a slit in a metal layer or in a metal card body.

FIG. 6B shows a metal transaction card with a recess to accommodate a carbon fiber layer with an opening for an inductive coupling chip module (ICM), with the carbon fiber camouflaging the slit in the metal layer or in the metal card body.

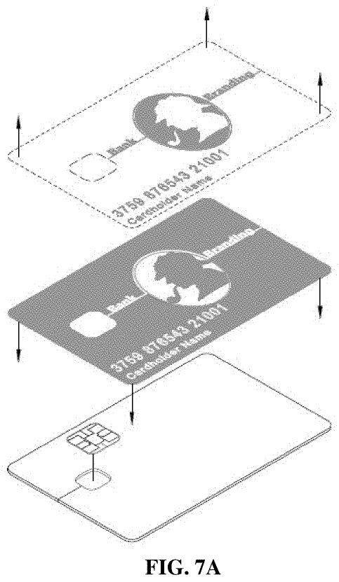

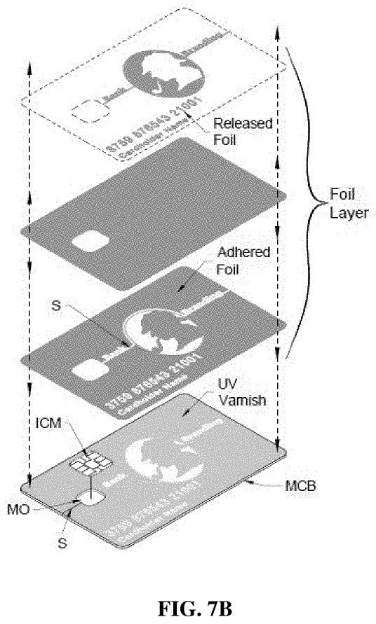

FIG. 7A shows a card embodying the invention showing a metal foil being applied to a transaction card.

FIG. 7B shows a card embodying the invention showing a metal foil with a slit for texturing the surface of a metal card body (MCB) and the production steps in applying the foil to the card body.

A textured conductive foil may be applied to the outer surface of a metal transaction card, with its surface acting as an antenna or coupling frame to drive a transponder chip module. Said textured conductive foil may be further laser etched to create additional decorative designs or security features.

The metal foil is located across the center of the card body with the module antenna overlapping a section of the metal foil. The metal foil may or may not have a slit to function as a coupling frame.

The metal foil may adhere to cured screen-printed UV varnish applied to the card body or to an array of card body sites (inlay), and depending upon the design, can achieve flat, tactile or 3D effects.

The design of the coupling frame antenna is integrated into the decorative areas, and all the details from the screen are printed with a UV varnish and covered by the foil.

The metal foil (in any color) may have an adhesive backing which is attached to the UV screen printed varnish, and because of surface tension, the foil only breaks-off (or releases) from the non-UV varnish screen printed areas, leaving the foil attached to the UV varnish creating the embossed effect. Alternatively, to an adhesive backing on the foil, an intermediate adhesive layer can be applied.

A laser may be used to create a slit, slot or notch in the metal foil so as to act as a coupling frame. A laser may be used to create a decorative design on the metal foil.

The screen-printed UV varnish may be applied directly to a front face metal layer (with slit), or the varnish may be applied to a synthetic layer laminated or attached to an underlying metal layer.

The metal foil may also be used to camouflage an underlying layer of metal having a slit to act as a coupling frame.

The metal foil on the outer surface of the transaction card body may also be used to regulate the system frequency of the transponder chip module coupled to a metal layer with slit within the card construction.

Patterned lamination plates may be used to create texture on a synthetic layer before the application of the UV varnish followed by the hot stamping of a metal foil layer thereon.

Metal layers in a transaction card may be provided with a decorative design using chemical etching techniques followed by laser etching to create color and to impart information on the card surface.

The exposed metal surface may be sand-blasted or highly polished and subsequently treated with a diamond-like-carbon or PVD coating.

A metal foil, holofoil or a holographic metal film (hot stamped, laminated, or pre-applied on a synthetic substrate to a card body or to an array of card bodies) may be provided with a discontinuity in the form of a slit to act as a coupling frame in order to facilitate contactless communication. The foil may be a decorative foil mounted to a card body containing a metal layer with a slit.

As a further embodiment of the invention, the decorative foil, textured foil or the holographic foil, applied to a metal layer or metal card body with a discontinuity, may not need a slit to function as a coupling frame, but rather the module antenna of the transponder chip module may only need to be partially surrounded by the foil, and not all 4 sides.

3D Printing of Coupling Frames and Electronic Components

Dual-material fused filament fabrication (3D printing) of conductive surfaces on a metal card body using conductive thermoplastic metal based filaments is an alternative technique to the use of metal foil stamping in producing a coupling frame. Dual material 3D printing may also be used to fabricate a discrete component such as an inductor, capacitor or a resistor on a surface forming part of a transaction card. Surface mounted components may be placed and connected to 3D printed structures or traces to enhance performance

As an alternative to chemical etching of metal, a metal card body with intricate recess structures may be 3D printed.

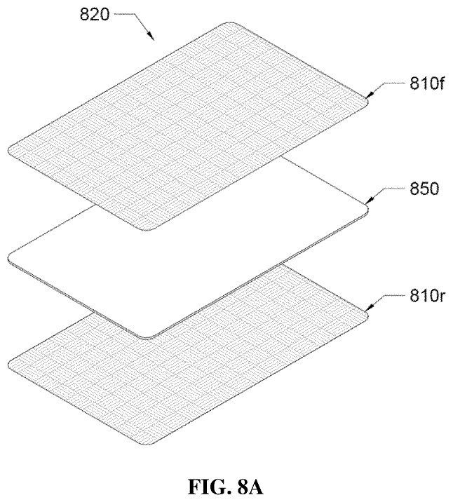

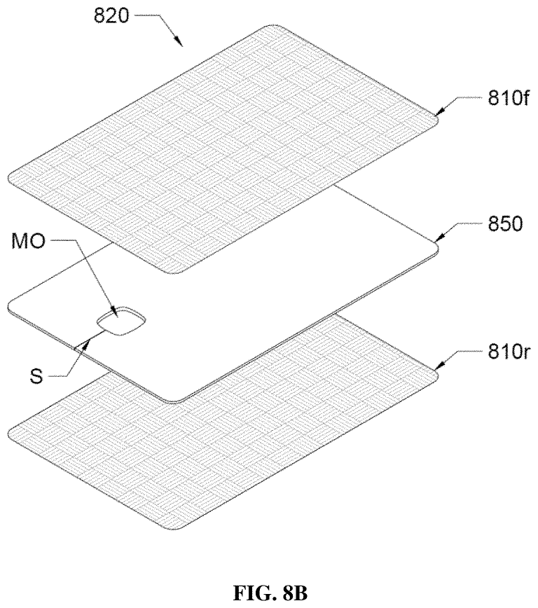

FIG. 8A shows the following exemplary stack-up of layers for a card 820 (a metal core layer sandwiched between two layers of carbon fiber), from a front surface (side) of the card to a rear surface (side) of the card:

a front carbon (or composite) fiber layer 810f
a rear carbon (or composite) fiber layer 810r
a metal layer with slit 850 sandwiched between the two fiber layers 810f/810r

FIG. 8A shows an example of a metal transaction card 820 comprising: a metal core layer 850 sandwiched between two layers of carbon fiber structure 810f and 810r. Compare FIG. 3 of U.S. Pat. No. 9,646,234

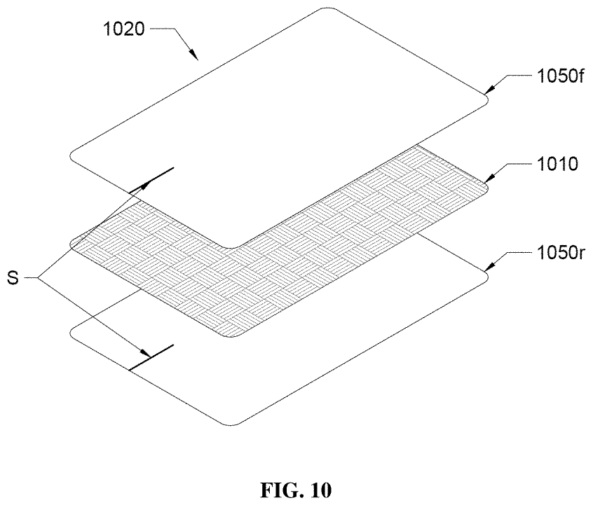

The metal core layer 850 may have a slit (S, not shown) to function as a coupling frame. (A slit in one of two metal layers 1050f and 1050r is shown in FIG. 10.)

For a detailed discussion of metal layers having slits to function as coupling frames, reference may be made to U.S. Pat. Nos. 9,475,086 and 9,798,968, incorporated by reference herein. Coupling frames may also have module openings for accepting a transponder chip module (TCM, not shown), which has at least contactless capability, and which may also have contact pads for a contact interface.

FIG. 8B is directed to a smartcard 820 comprising:
a metal layer 850 having two sides (surfaces) and a slit and a module opening to function as a coupling frame;
a first composite layer 810r (or 810f) of fibrous material disposed on one side of the first metal layer; and
a second composite layer 810f (or 810r) of fibrous material disposed on the other side of the first metal layer, thereby sandwiching the metal layer between the two composite layers.

Stated otherwise, a method of making a metal transaction card, may comprise:
providing a metal core layer 850 with a slit and module opening acting as a coupling frame; and
enclosing the metal core layer at least in part on each side by a composite layers 810f and 810r of fibrous material to form a card core.

An over-laminate film may be disposed (laminated) onto each of two opposing faces of the resulting fiber/metal/fiber card core. At least one of the over-laminate films may comprise a transparent film which is laser engravable. Alternatively, hard coat film layer may be laminated on the opposing front and rear faces of the card core.

The composite layers of fibrous material illustrated in FIGS. 8 and 10 (below) may comprise: fiber strands or filaments selected from the group consisting of mineral fiber strands or filaments, glass fiber strands or filaments, metal fiber strands or filaments, and polymer fiber strands and filaments in a certain pattern.

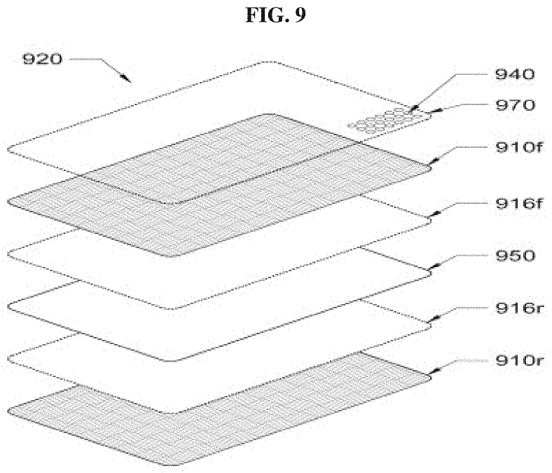

FIG. 9 shows an example of a metal transaction card 920 comprising:
a metal core layer 950 with slit (not shown) to function as a coupling frame sandwiched between two layers of carbon fiber structure 910f and 910r, laminated together using adhesive layers 916f and 916r.

Optionally, a hard coat layer 970 or a laser engravable overlay layer may be disposed on the front carbon fiber layer 910f.

In FIG. 9, the element 940 represents the operation of laser treating the scratch protective coating, protective layer, a laser engravable overlay layer, or any laser reactive layer.

The outer (external) surfaces of the carbon fiber structures 910f and 910r can be printed with various text, graphics, logos, account numbers, and the like, and a thin layer over-laminate of clear plastic (overlay), such as PVC plastic film, can be applied to the outer surface. The overlay can be laser engraved with card holder credentials.

FIG. 10 shows a card 1020 having a carbon fiber structure (layer) 1010 sandwiched between two metal layers 1050f and 1050r. The metal layers may each have slits (s), which are visible in the front and rear metal layers 1050, so that the metal layers may function as coupling frames (as discussed hereinbefore).

FIG. 10 shows a smartcard 1020 comprising:
a first metal layer 1050f having two sides (surfaces) and a slit to function as a coupling frame;
a second metal layer having two sides (surfaces) and a slit to function as a coupling frame disposed on another side of the composite layer; and
a composite layer 1010 of fibrous material sandwiched between the two metal layers.

FIG. 10 is illustrative of a method of making an RFID-enabled metal transaction card 1020, comprising:
providing a composite layer 1010 of fibrous material arranged in a certain pattern; and
enclosing the composite layer of fibrous material at least in part on both sides by metal layers 1050f and 1050r having slits to function as coupling frames;
wherein the resulting sandwich structure of metal-composite-metal forms a card core.

In either of the FIG. 8 or FIG. 10 embodiments, some of the following steps may be performed (creating resulting structures) as may be applicable to the particular embodiment:

FIG. 10: the composite layer 1010 of fibrous material may be enclosed, at least in part, on each side by an adhesive film (not shown) comprising a material selected from the group consisting of polyethylene, acrylic, cyanoacrylate, and epoxy.
FIG. 10: printing on at least one of the two opposing faces of the transaction card core—i.e., on the outer, exposed surfaces of the front and back metal layers 1050f and 1050r.

It should be noted that it is not practical to print directly on the carbon fiber. Rather, the printing may be performed on a laminate or hard coat applied thereto

Although not shown, over-laminate films may be laminated to the front and back opposing faces of the resulting card core. The over-laminate films may comprise a transparent film which is laser engravable. Alternatively, a hard coat film layer may be laminated on each of opposing faces of the card core. The surface properties of the hard coat film layer may have a surface energy which is receptive to over printing and hot-stamping of a payment scheme hologram.

As an embodiment of the invention, transparent inks, varnishes and polymer coatings are applied to raw, coated/uncoated, and or ink printed metal inlays, with the films or layers of ink, varnish or polymer intended to act as a protective coating on the outer surface of a metal card body, to exhibit good abrasion, chemical resistance and scratch resistance properties. The protective coating may be laser marked or laser engraved depending on its material composition.

The laser type may be a nanosecond, picosecond or femtosecond laser firing pulses to mark or ablate a surface at wavelengths between ultraviolet (UV), visible and infrared (IR). The pulse duration may be variable and adjustable in steps. The surface of the marked or ablated coating should have well defined edges, with no carbonization (degradation) of the surface after laser treatment.

The print/coat system may be composed of coats of ink or paint, a topcoat (protective coating of ink, varnish or a polymer over the ink/paint layer) and a basecoat (primer) which have been applied sequentially on the metal inlay, with a laser beam ablating the topcoat to reveal the metal (laser engraving) to generate the characters or logos. Alternatively, the laser beam may just surface mark the topcoat with alphanumeric characters (laser personalization), with minimum material removal. Also thin film effects without material removal can be accomplished by the laser light, resulting in oxidation of the surface to form colorful patterns.

The protective coating composition may comprise of additives: a viscosity modifier, a cure accelerator (catalyst), colorants/pigments, adhesion promoters, energy transfer agents, surface tension modifying agents, crosslinking agents, plasticizers or a laser marking additive (particulates and or metallic powder) that change color under the action of the laser beam.

The opacity of the laser responsive coating may change substantially when exposed to laser irradiation which further depends on the underlying printed ink layer (pantone colors and shades), the baking cycle of the coating, and curing speed (depending on ink color, opacity, number of color components in blend and processing parameters).

The films of ink, varnish or polymer with a given thickness (multiple liquid layers) on a metal surface may exhibit different ablation etch rates of the corresponding coating material under the same irradiation conditions.

Laser marking or laser engraving of metal cards is typically performed using a 20-watt fiber laser working in the infrared range of 1064 nm with laser pulse durations in nanoseconds, but depending on the coating composition, other wavelengths and pulse durations at a given laser beam intensity may provide the best results in terms of surface morphology.

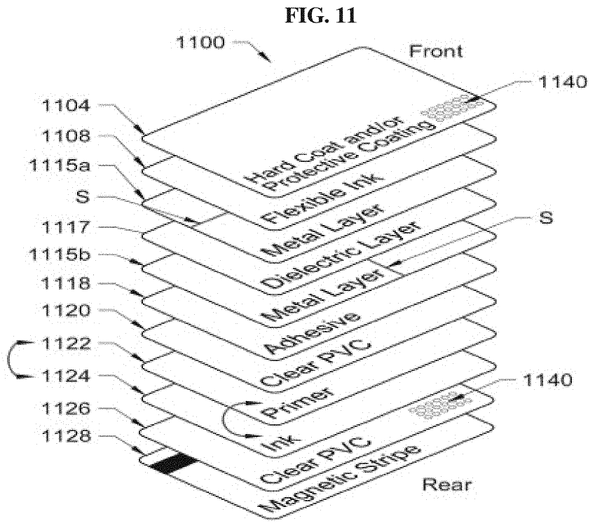

FIG. 11 is a simplified cross-sectional diagram of a “hybrid” metal card assembly for
manufacturing a metal transaction card that can be personalized on the front and rear surfaces using a laser beam, according to the invention.

An exemplary stack-up of the card 1100 is illustrated (from front-to-rear), comprising:
1104 hard coat and or protective coating (ink, varnish or a polymer coating)
1108 ink (flexible ink)

The hard coat layer and or the protective coating undergoes (may receive) laser treatment 1140 to personalize the card.

Metal Inlay (2 layers of 8 mils metal with slits separated by a dielectric layer) 18 mils
1115a metal layer
1117 dielectric
1115b metal layer
   * the metal layers 1115a, 1115b may have slits (S) to function as coupling frames (CF)
1118 adhesive
1120 clear PVC
   1122 primer
   1124 ink (printed information (PI))
1126 clear PVC
   1140 represents information inscribed into and onto the clear PVC 1126
1128 magnetic stripe

Metal cards are often desired to have a single color scheme rather than having busy graphics which require specialized printing. The metal cards can be digitally printed using UV inks and protected by a hard coat as proposed below.

The protective coating may be replaced by a powder coating. A 3D effect may be produced in the protective coating.

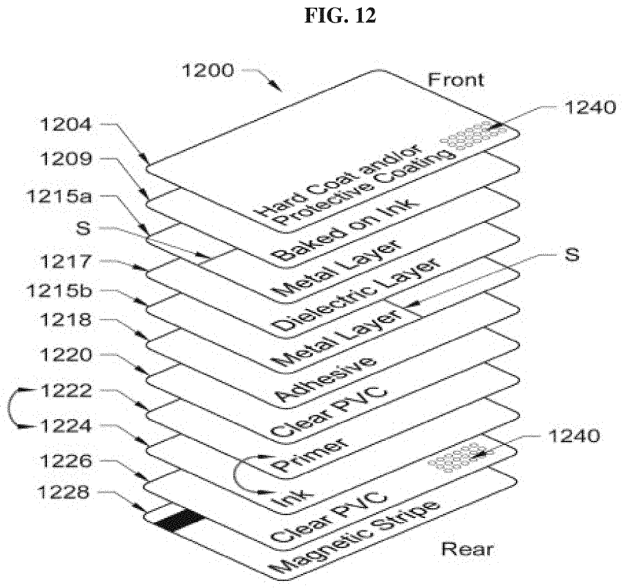

FIG. 12 depicts a metal face transaction card having an exposed metal surface with a flat color or a color with a grain structure which has been baked on at an elevated temperature (˜400° F.). The hard coat protects the underlying color coated metal layer which can be laser etched to personalize the transaction card. The slit in the metal layer is partially disguised by the baked-on ink. The surface can be mechanically engraved to create a payment scheme logo. The stack-up construction comprises:
Hard coat layer and or protective coating (ink, varnish or a polymer coating)
Metal layer with baked-on-ink having a slit for contactless communication
Adhesive Layer
Print Layer with a matching color to the metal layer
Overlay layer with magnetic stripe which is laser engravable

An exemplary stack-up of the card 1200 is illustrated (from front-to-rear):
1204 hard coat and or protective coating (ink, varnish or a polymer coating)
The hard coat layer and or the protective coating undergoes laser treatment 1140 to personalize the card.
1209 baked on ink layer (primer, ink, protective coating (polyurethane, a blend of polyester and polyurethane, acrylic or epoxy))
Metal Inlay (2 layers of metal (12 mils and 6 mils) with slits (fish hook shape) separated by a dielectric layer) 20.5 mils
1215a metal layer
1217 dielectric
1215b metal layer
   * the metal layers 1215a, 1215b may have slits (S) to function as coupling frames (CF)
1218 adhesive
1220 clear PVC
   1222 primer
   1224 ink (printed information (PI))
1226 clear PVC
1228 magnetic stripe

Protective Coatings and Laser Treatment (Thin Film Effects, Laser Marking and Laser Engraving)

Anti-scratch protective coatings which protect an underlying print layer require laser treatment to create special thin film effects, laser markings for personalization, and laser engraving for etching features into the surfaces of a metal card such as a payment scheme logo. The material composition of the laser responsive coatings plays a crucial role in the marking and ablation processes, but equally the correct selection of the laser source in terms of fluence, wavelength, pulse duration, repetition rate and the application of gas is very important. The metal surface is typically covered with one or more layers of a protective polymer coating such as a urethane, polyester, or an acrylic base coating. The protective polymers may also be a blend of polyurethane and polyester. The gloss level (low or high) depends on the quality and smoothness of the metal surface, the color of the underlying ink or paint, the thickness and type of coatings applied and the use of any dulling agents. Transparent varnishes and inks may also be used as the protective coating.

Application in Metal Cards

Transparent inks, varnishes and polymer coatings are applied to raw, coated/uncoated, and or ink printed metal inlays, with the films or layers of ink, varnish or polymer intended to act as a protective coating on the outer surface of a metal card body, to exhibit good abrasion, chemical resistance and scratch resistance properties. The protective coating may be laser marked or laser engraved depending on its material composition.

The laser type may be a continuous wave (CW), nanosecond, picosecond or femtosecond laser firing pulses to mark or ablate a surface at wavelengths between ultraviolet (UV), visible and infrared (IR). The pulse duration may be variable and adjustable in steps. The surface of the marked or ablated coating should have well defined edges, with no carbonization (degradation), minimal heat affected zone (HAZ), delamination of the surface after laser treatment.

The print/coat system may be composed of coats of ink or paint, a topcoat (protective coating of ink, varnish or a polymer over the ink/paint layer) and a basecoat (primer) which have been applied sequentially on the metal inlay, with a laser beam ablating the topcoat to reveal the metal (laser engraving) to generate the characters or logos. Alternatively, the laser beam may just surface mark the topcoat with alphanumeric characters (laser personalization), with minimum material removal. Also, thin film effects without material removal can be accomplished by the laser light, resulting in oxidation of the surface to form colorful patterns.

The protective coating composition may comprise of additives: a viscosity modifier, a cure accelerator (catalyst), colorants/pigments, adhesion promoters, energy transfer agents, surface tension modifying agents, crosslinking agents, plasticizers or a laser marking additive (particulates and or metallic powder) that change color under the action of the laser beam.

The opacity of the laser responsive coating may change substantially when exposed to laser irradiation which further depends on the underlying printed ink layer (pantone colors and shades), the baking cycle of the coating, and curing speed (depending on ink color, opacity, number of color components in blend and processing parameters).

The films of ink, varnish or polymer with a given thickness (multiple liquid layers) on a metal surface may exhibit different ablation etch rates of the corresponding coating material under the same irradiation conditions.

Laser marking or laser engraving of metal cards is typically performed using a 20-watt fiber laser working in the infrared range of 1064 nm with laser pulse durations in nanoseconds (in the range from 20 to 200 ns), but depending on the coating composition, other wavelengths and pulse durations at a given laser beam intensity may provide the best results in terms of surface morphology.

While the invention(s) may have been described with respect to a limited number of embodiments, these should not be construed as limitations on the scope of the invention(s), but rather as examples of some of the embodiments of the invention(s). Those skilled in the art may envision other possible variations, modifications, and implementations that are also within the scope of the invention(s), and claims, based on the disclosure(s) set forth herein.

What is claimed is:

1. An RFID-enabled smartcard comprising:
a metal layer having a scratch protection coating over a print layer on its front face, wherein the scratch protection coating comprises at least one of (i) a layer of ink, varnish or a polymer and (ii) a layer of hard coat lamination film;
wherein the scratch protection coating is suitable for one or more of the following treatments:
the scratch protection coating is capable of being laser marked for inscribing personalization data into or onto the coating;
the scratch protection coating is capable of being laser engraved to partially remove the coating in creating a logo or a deboss feature; and
the scratch protection coating is capable of being laser treated without removal of material to create thin film effects.

2. The RFID-enabled smartcard of claim 1, wherein:
the metal layer is capable of being laser marked or laser engraved.

3. The RFID-enabled smartcard of claim 1, wherein:
a laser for performing the laser marking, engraving or treatment has a wavelength in the UV, IR or visible, and may have a varying pulse width in the nanosecond, picosecond or femtosecond regime.

4. A multi-layered composite metal transaction card comprising:
a plastic layer having top and bottom surfaces attached to a metal layer; and
a metal layer with a discontinuity in the form of a micro-slit at a designated area with said metal layer residing at the front face, rear face or at the core of the transaction card;
wherein a security layer is assembled to or formed on the designated area of the metal layer with said security layer camouflaging or covering the discontinuity; and
wherein said metal layer acts as a radio frequency antenna and the security layer does not attenuate the field.

5. The multi-layered composite metal transaction card of claim 4, wherein:
the security layer is electromagnetically transparent.

6. The multi-layered composite metal transaction card of claim 4, wherein:
the security layer comprises a hologram or diffraction grating disposed on a metal foil or on a very thin metal layer which is formed or grown at the designated area on the metal layer.

7. The multi-layered composite metal transaction card of claim 4, wherein:
the security layer comprises an embossed or debossed pattern.

8. The multi-layered composite metal transaction card of claim 4, wherein:
the security layer, with or without a carrier layer, is mounted or assembled directly to a designated area on the metal layer by means of hot stamping, spot or laser welding.

9. The multi-layered composite metal transaction card of claim 4, further comprising:
a plastic layer, which may be a clear plastic layer attached to the metal layer, having information selectively written thereon; and
at least one window or opening formed within the plastic layer to enable visibility of the hologram or diffraction grating on the security layer.

10. A metal face transaction card comprising:
a transaction card structure comprising a layer or layers of metal with a slit; and
a plastic layer or a combination of plastic layers laminated on one of the two opposing faces of the metal layer or layers to form an RFID-enabled metal transaction card body;
wherein the layer of metal of the transaction card comprises a decorative metal foil layer on a UV screen printed layer;
wherein the decorative metal foil layer has a discontinuity to act as a coupling frame in order to power a transponder chip module; and
wherein the decorative metal foil layer imparts texture to the card body surface.

11. The metal face transaction card of claim 10, wherein:
the discontinuity is an integral part of the decorative metal foil pattern.

12. The metal face transaction card of claim 10, wherein:
the metal foil layer comprise lasers etched elements for design and alphanumeric information of a cardholder.

13. The metal face transaction card of claim 10, wherein:
the metal foil layer has multiple colors and design patterns.

14. The metal face transaction card of claim 10, wherein:
the plastic layer or a combination of plastic layers capture a magnetic stripe.

15. The metal face transaction card of claim 10, wherein:
the plastic layer or a combination of plastic layers capture security elements.

16. The metal face transaction card of claim 10, wherein:
the plastic layer is protected by a laser engravable overlay layer.

17. A metal face transaction card comprising:
a layer or layers of metal with a slit; and
a plastic layer or a combination of plastic layers laminated on one of the two opposing faces of the metal layer or layers to form an RFID-enabled metal transaction card body;
wherein the layer of metal of the transaction card comprises a decorative metal foil layer on a UV screen printed layer.

18. The metal face transaction card of claim 17, wherein:
the decorative metal foil layer regulates the system frequency of the combined operation of the transponder chip module and the metal layer or layers with a slit acting as a coupling frame.

19. The metal face transaction card of claim 17, wherein:
the decorative metal foil layer imparts texture to the card body surface and camouflages a slit or slits in the underlying metal layer or layers.
